(19) United States
(12) Patent Application Publication
(10) Pub. No.: US 2026/0338992 A1
(43) Pub. Date: Oct. 29, 2026

(54) NEAR-INFRARED-ABSORBING COMPOSITION, AND OPTICAL MEMBER

(71) Applicant: Konica Minolta, Inc., Tokyo (JP)

(72) Inventors: Natsumi KIRIISHI, Hino-shi, Tokyo (JP); Takayuki SUZUKI, Kokubunji-shi, Tokyo (JP); Kaori ONO, Ichihara-shi, Chiba (JP); Kenji HAYASHI, Hachioji-shi, Tokyo (JP)

(21) Appl. No.: 19/481,075

(22) PCT Filed: Apr. 22, 2024
(86) PCT No.: PCT/JP2024/015666

§ 371 Date: Nov. 3, 2025

(30) Foreign Application Priority Data
May 18, 2023 (JP) 2023-082045

(51) Int. Cl. G02B 1/04; C08G 65/48; C08K 5/01; C08K 5/3435; C08K 5/37; C08K 5/5397; G02B 5/20

(52) U.S. Cl. CPC G02B 1/04; C08G 65/48; C08K 5/01; C08K 5/3435; C08K 5/37; C08K 5/5397; G02B 5/208

(57) ABSTRACT

The present invention provides: a near-infrared-absorbing composition that has the antioxidant function of a solvent but is less likely to result in discoloration; and an optical member that uses said composition. This near-infrared-absorbing composition contains a copper phosphonate complex, a phosphoric acid ester, an ether-based solvent, and an antioxidant, and contains, as the antioxidant, at least one selected from antioxidants having a structure represented by any one of general formulas (1)-(5).

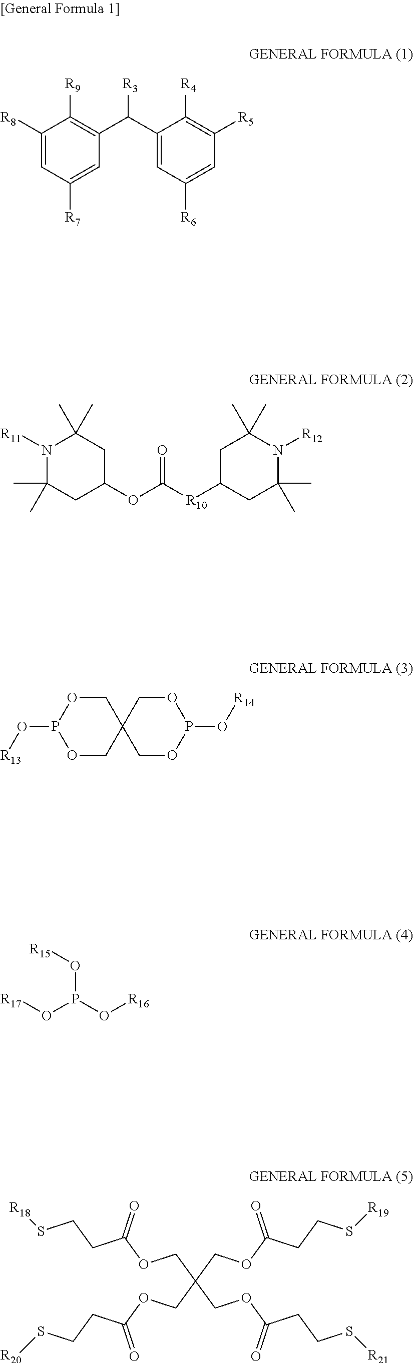

### TECHNICAL FIELD

The present invention relates to a near-infrared light absorbing composition and an optical member. More specifically, the present invention relates to the near-infrared light absorbing composition which is resistant to coloring while having a function of preventing oxidation of a solvent, and an optical member using such near-infrared light absorbing composition.

### BACKGROUND ART

In a solid state imaging device, a near-infrared light cut filter is used. One type of the near-infrared light cut filter is manufactured by curing a liquid near-infrared light absorbing composition containing a copper compound. When the near-infrared light absorbing composition containing the copper compound is prepared, an ether-based solvent such as tetrahydrofuran is often used for the purpose of dissolving copper acetate or the like.

There is a concern that an ether-based solvent generates a peroxide which has a risk of explosion. Therefore, an antioxidant may be added to the near-infrared light absorbing composition which may contain the ether-based solvent.

Patent Document 1 and Patent Document 2 disclose a technique of adding a hindered phenol-based antioxidant to the near-infrared light absorbing composition which may contain the ether-based solvent.

However, it has been found that in a case where the copper compound and the hindered phenol-based antioxidant are used in combination, a cured film formed from the near-infrared light absorbing composition is colored in a curing process or the like.

### CITATION LIST

### Patent Literature

Patent Document 1: International Publication No. 2014/027639
Patent Document 2: Japanese Unexamined Patent Publication No. 2014-032380

### SUMMARY OF INVENTION

### Technical Problem

The present invention has been made in consideration of the above-described problems and situations, and a problem to be solved by the present invention is to provide a near-infrared light absorbing composition that is unlikely to be colored while having a function of preventing oxidation of a solvent, and an optical member using such near-infrared light absorbing composition.

### Solution to Problem

In order to solve the above problem, the present inventors have studied the cause of the above problem and the like. As a result, the present inventors have found that the above-mentioned problems can be solved by containing an antioxidant having a specific structure in a near-infrared light absorbing composition containing a copper phosphonate complex, a phosphate ester, and an ether-based solvent, and have completed the present invention.

That is, the above-described problems according to the present invention are solved by the following means.

1. A near-infrared light absorbing composition including:
a copper phosphonate complex,
wherein the near-infrared light absorbing composition further includes, a phosphate ester, a solvent, and an antioxidant,
wherein the near-infrared light absorbing composition includes at least an ether-based solvent as the solvent, and
wherein the near-infrared light absorbing composition includes as the antioxidant, at least one type selected from a phenol-based antioxidant having a structure represented by the following General Formula (1), an amine-based antioxidant having a structure represented by the following General Formula (2), a phosphorus-based antioxidant having a structure represented by the following General Formula (3) or (4), and a sulfur-based antioxidant having a structure represented by the following General Formula (5).

### [Chemical Formula 1]

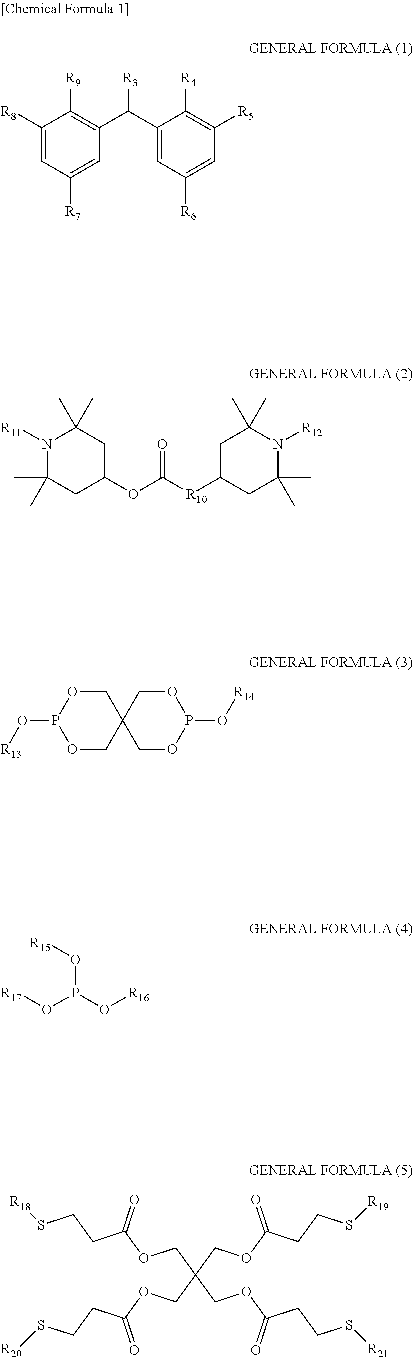

[In the General Formulas (1) to (5), R₃ is the alkyl group having 1 to 4 carbon atoms. R₄ to R₉ are substituent groups selected from a hydroxy group, an acyloxy group, and the alkyl group. At least one among R₄ to R₉ is the hydroxy group, and at least one of the others is the acyloxy group. R₁₀ is oxygen or the alkylene ester group having 1 to 20 carbon atoms, and may further have a substituent group. R₁₁ and R₁₂ are hydrogen, the alkyl group having 1 to 20, or an alkoxy group having 1 to 20 carbon atoms. R₁₃ to R₂₁ are the alkyl group or an aryl group having 1 to 20 carbon atoms, and may further have the substituent group. R₁₅ and R₁₆ may be bonded to each other.]

2. The near-infrared light absorbing composition according to aspect 1, further including a titanium coupling agent.

3. The near-infrared light absorbing composition according to aspect 1, wherein an acetate ion concentration is 0.5% by mass or less.

4. The near-infrared light absorbing composition according to aspect 1, wherein the phosphate ester has a structure represented by the following General Formula (II).

### [Chemical Formula 2]

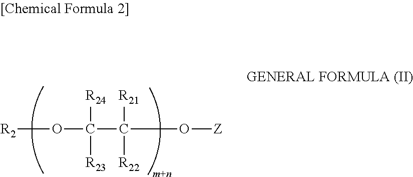

[In the General Formula (II), R₂ represents the alkyl group having 1 to 20 carbon atoms or the aryl group having 6 to 20 carbon atoms, and may further have the substituent group. R₂₁ to R₂₄ each independently represents a hydrogen atom or an alkyl group having 1 to 4 carbon atoms. m represents an average addition number of a partial structural unit in which all of R²¹ to R²⁴ are hydrogen atoms, and is in a range of 1 to 19. n represents an average addition number of a partial structural unit in which at least one of R²¹ to R₂₄ is an alkyl group having 1 to 4 carbon atoms, and is in a range of 1 to 19. m+n is a total number of m and n, and is in a range of 2 to 20. Z represents a structural unit selected from the following formula (Z-1) and formula (Z-2).]

### [Chemical Formula 3]

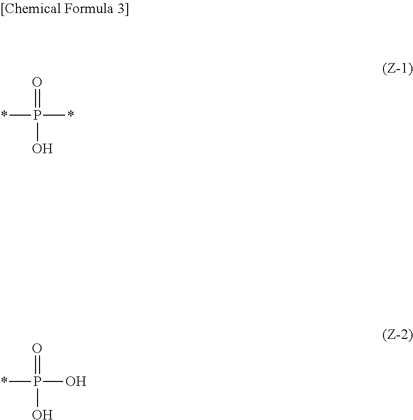 [SMILES: *P(*)(=O)O ; *P(=O)(O)O]

5. The near-infrared light absorbing composition according to aspect 1, further including, as the antioxidant, at least one type selected from the phenol-based antioxidant and the amine-based antioxidant and at least one type selected from the phosphorus-based antioxidant and the sulfur-based antioxidant.

6. The near-infrared light absorbing composition according to aspect 1, further including, as the antioxidant, at least one type selected from the phenol-based antioxidant and the amine-based antioxidant.

7. The near-infrared light absorbing composition according to aspect 1, wherein a content of the solvent is within a range of 61 to 98% by mass.

8. An optical member including:
a cured product of the near-infrared light absorbing composition according to any one of aspects 1 to 6.

### Advantageous Effects of Invention

According to the above-described means of the present invention, a near-infrared light absorbing composition that is unlikely to be colored while having a function of preventing oxidation of a solvent, and an optical member using such near-infrared light absorbing composition can be provided.

Although the realization mechanism or action mechanism of the effects of the present invention is not clear, the present inventors infer the mechanism as follows.

When hydrogen is released from an ether-based solvent (RH), R· radical is generated. The R· radical reacts with oxygen to become a ROO· radical. When the ROO· radical reacts with the ether-based solvent (RH), a peroxide (ROOH) and an R· radical (1) are generated. The peroxide (ROOH) is decomposed into an RO· radical and an ·OH radical, and when these radicals react with the ether-based solvent (RH), ROH, H₂O, and an R· radical (2) are generated. The two generated R· radicals (1) and (2) each react with oxygen to form ROO· radicals, and the cycle described above is repeated in a chain reaction. Due to such chain reaction, the amount of peroxide (ROOH) increases. As described above, the ether-based solvent is likely to generate a peroxide. Since the peroxide is explosive, the ether-based solvent has a risk of explosion.

On the other hand, a radical chain inhibitor such as a phenol-based antioxidant or an amine-based antioxidant prevents ROO· radicals from reacting with an ether-based solvent (RH) to generate R· radicals, thereby suppressing a radical chain reaction. In addition, a peroxide decomposer such as a phosphorus-based antioxidant and a sulfur-based antioxidant suppresses the chain reaction while reducing the peroxide (ROOH) by reducing the peroxide (ROOH) to ROH. Therefore, even in the case of a composition containing the ether-based solvent, the risk of explosion can be suppressed by further containing such antioxidant.

Here, it is known that a hindered phenol-based antioxidant which is generally used as the antioxidant is easily colored due to various factors such as heat. In the near-infrared light absorbing composition containing a copper compound, dibutylhydroxytoluene (BHT) or Irganox 1010 (manufactured by Basf SE), which is a general hindered phenol-based antioxidant, reacts with, for example, copper to be colored yellow. Therefore, although the oxidation of the ether-based solvent is suppressed in the near-infrared light absorbing composition containing the hindered phenol-based antioxidant, there is a problem in the optical characteristic of a cured film to be formed.

In contrast, the antioxidant according to the present invention includes a structure represented by any one of General Formulas (1) to (5). The antioxidant having the structure represented by any one of General Formulas (1) to (5) is less likely to be colored because of the difference in structure from dibutylhydroxytoluene (BHT) or Irganox 1010 (manufactured by Basf SE) which is the general hindered phenol-based antioxidant. Therefore, the near-infrared light absorbing composition of the present invention containing the antioxidant having a structure represented by any one of General Formulas (1) to (5) is hardly colored.

### BRIEF DESCRIPTION OF DRAWINGS

FIG. 1 This is a schematic cross-sectional view showing an example of a configuration of a near-infrared light cut filter.

FIG. 2 This is a schematic cross-sectional view showing an example of a configuration of an image sensor for a solid state imaging device.

FIG. 3 This is a schematic cross-sectional view showing an example of a configuration of a camera module.

### DESCRIPTION OF EMBODIMENTS

A near-infrared light absorbing composition according to the present invention is a near-infrared light absorbing composition containing a copper phosphonate complex, further containing a phosphate ester, a solvent, and an antioxidant, wherein the solvent contains at least an ether-based solvent, and the antioxidant contains at least one type selected from antioxidants having structures represented by the aforementioned General Formulas (1) to (5).

This feature is a technical feature common to or corresponding to the following embodiments.

According to an embodiment of the present invention, it is preferable that a titanium coupling agent is further contained. Thus, a dispersion stability of the copper phosphonate complex is improved, and therefore, haze of a cured film formed from the near-infrared light absorbing composition decreases, and visible light transmittance becomes satisfactory. In addition, due to formation of a film of the titanium coupling agent by a crosslinking reaction of the titanium coupling agent, penetration of water from the film surface can be suppressed, and the moisture resistance of the cured film is improved. In addition, since the titanium coupling agent film also blocks oxygen, generation of a peroxide derived from an ether-based solvent can be suppressed. In addition, due to physical adsorption or crosslinking between the titanium coupling agent and the copper phosphonate complex, thermal vibration of the copper phosphonate complex is suppressed, and heat resistance of the cured film is improved.

According to an embodiment of the present invention, acetate ion concentration is preferably 0.5% by mass or less. A near-infrared light absorbing composition containing a copper complex generally uses copper acetate at the time of preparation. Therefore, the near-infrared light absorbing composition often contains acetate ions. However, the acetate ion reduces the dispersion stability of the copper phosphonate complex and also inhibits the function of the antioxidant. Therefore, the acetate ion concentration is preferably low. Specifically, when the acetate ion concentration is 0.5% by mass or less, it is possible to suppress a reduction in the dispersion stability of the copper phosphonate complex and inhibition of the function of the antioxidant.

According to an embodiment of the present invention, it is preferable that the phosphate ester has the structure represented by the General Formula (II) described above, from the viewpoints of dispersibility and dispersion stability of the copper phosphonate complex.

According to an embodiment of the present invention, it is preferable that at least one type selected from the phenol-based antioxidant and the amine-based antioxidant and at least one type selected from the phosphorus-based antioxidant and the sulfur-based antioxidant are contained as the antioxidant, from the viewpoint of suppressing an increase in the peroxide.

According to an embodiment of the present invention, it is preferable that the composition contains, as the antioxidant, at least one type selected from the phenol-based antioxidants and the amine-based antioxidants, from the viewpoint of suppressing an increase in the peroxide and from the viewpoint of having a small influence on optical characteristics of the cured film.

According to an embodiment of the present invention, it is preferred that a content of the solvent is in a range of 61 to 98% by mass. When the content is within this range, the dispersion stability is further improved, and long-term storage can be achieved.

An optical member according to the present invention includes a cured product of the near-infrared light absorbing composition according to the present invention.

Hereinafter, the present invention, constituent elements thereof, and forms and aspects for carrying out the present invention will be described in detail. In the present description, numerical values described before and after “to” are included in a range as a lower limit value and an upper limit value.

### [Outline of Near-Infrared Light Absorbing Composition of the Present Invention]

The near-infrared light absorbing composition of the present invention is the near-infrared light absorbing composition containing the copper phosphonate complex, further containing the phosphate ester, the solvent, and the antioxidant, wherein at least the ether-based solvent is contained as the solvent, and at least one type of the antioxidants has a structure represented by any of the General Formulas (1) to (5) described later.

### [Copper Phosphonate Complex]

The near-infrared light absorbing composition of the present invention contains the copper phosphonate complex. The copper phosphonate complex is a complex in which phosphonic acid is coordinated to copper. The copper phosphonate complex absorbs the near-infrared light and contributes to adjustment of the transmitted light to a desired waveform.

The copper phosphonate complex is preferably a copper complex of phosphonic acid having a structure represented by the following General Formula (I).

### [Chemical Formula 4]

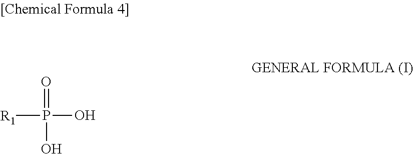

[In the above General Formula (I), R₁ represents an alkyl group having 1 to 20 carbon atoms or an aryl group having 6 to 20 carbon atoms, and may further have a substituent group.]

Examples of substituent groups which may be possessed by R₁ include, for example, the alkyl group (for example, a methyl group, an ethyl group, a trifluoromethyl group, and an isopropyl group), an alkoxy group (for example, a methoxy group, an ethoxy group, and the like), a halogen atom (for example, fluorine atom and the like), a cyano group, a nitro group, a dialkylamino group (for example, a dimethylamino group), trialkylsilyl group (for example a trimethylsilyl group and the like), a triarylsilyl group (for example, a triphenylsilyl group), a triheteroarylsilyl group (for example, tripyridylsilyl group etc), a benzyl group, a heteroaryl group (for example, a pyridyl group, a carbazolyl group, and the like), and as a condensed ring, 9,9′-dimethylfluorene, carbazole, dibenzofuran and the like.

R₁ is preferably the alkyl group having 1 to 20 carbon atoms in terms of excellent moist/heat resistance and near-infrared light absorption properties. R₁ is more preferably the alkyl group having 1 to 4 carbon atoms from the viewpoint that both of the near-infrared light absorption properties and visible transmittance can be achieved.

Examples of the phosphonic acid in which R₁ is the alkyl group having 1 to 20 carbon atoms include methylphosphonic acid, ethylphosphonic acid, propylphosphonic acid, butylphosphonic acid, pentylphosphonic acid, hexylphosphonic acid, heptylphosphonic acid, octylphosphonic acid, nonylphosphonic acid, decylphosphonic acid, and the like.

Examples of the phosphonic acid in which R₁ is the aryl group having 6 to 20 carbon atoms include phenylphosphonic acid, 4-methoxyphenylphosphonic acid, 4-aminophenylphosphonic acid, 4-bromophenylphosphonic acid, 3-phosphonobenzoic acid, 4-phosphonobenzoic acid, and 4-hydroxyphenylphosphonic acid.

The following compounds (H-1) to (H-8) are examples of the phosphonic acid.

### [Chemical Formula 5]

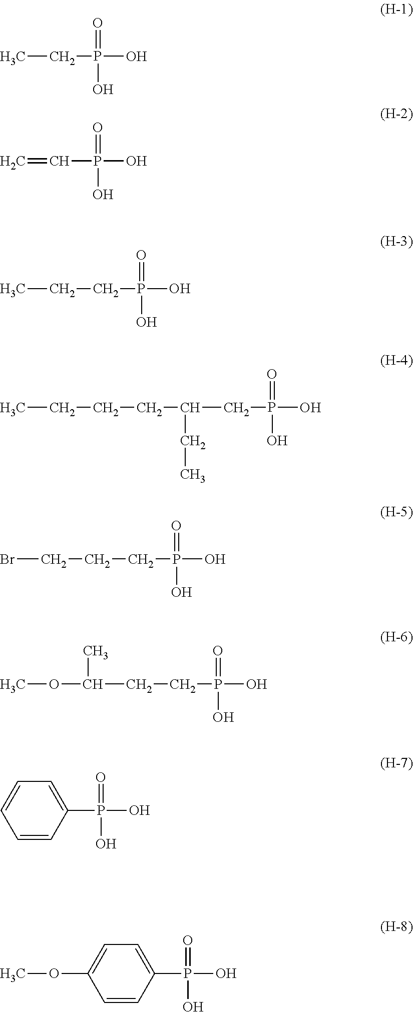

In the present invention, the phosphonic acid is preferably at least one type of alkylphosphonic acid selected from the following phosphonic acid group.
Methylphosphonic acid
Ethylphosphonic acid
Propylphosphonic acid
Butylphosphonic acid
Pentylphosphonic acid
Hexylphosphonic acid
Octylphosphonic acid
2-Ethylhexylphosphonic acid
2-Chloroethylphosphonic acid
3-Bromopropylphosphonic acid
3-Methoxybutylphosphonic acid
1,1-Dimethylpropylphosphonic acid
1,1-Dimethylethylphosphonic acid
1-Methylpropylphosphonic acid

The structure of the copper phosphonate complex is, for example, represented by the following General Formula (IC).

### [Chemical Formula 6]

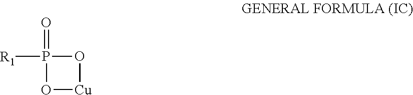

The R₁ in the General Formula (I) is the same as the R₁ in the General Formula (IC).

In the General Formula (IC), two reactive hydroxy groups of the compound having a structure represented by the General Formula (I) are both formed by reacting with the same copper ion, but the form of the copper phosphonate complex is not limited thereto. The term “reactive hydroxy group” refers to, among the hydroxy groups of the phosphonic acid, the hydroxy group directly bonded to a phosphorus atom.

In the near-infrared light absorbing composition, the copper phosphonate complex is mainly in the form of fine particles.

As a copper ion source of the copper phosphonate complex, a copper salt capable of supplying divalent copper ions is used.

Examples of sources of copper ions include copper salts of organic acids or copper salts of inorganic acids.

Specific examples of the copper-ion source include copper salts of organic acids such as acetic anhydride copper, anhydrous copper formate, anhydrous copper stearate, copper benzoate anhydride, copper acetoacetate anhydride, anhydrous copper ethylacetoacetate, copper methacrylate anhydride, copper pyrophosphate anhydride, copper naphthenate anhydride, anhydrous copper citrate, a hydrate of a copper salt of any of these organic acids; copper salts of inorganic acids such as copper oxide, copper chloride, copper sulfate, copper nitrate, copper phosphate, basic copper sulfate, basic copper carbonate, a hydrate of a copper salt of any of these inorganic acids; copper hydroxide and the like.

The content of the copper phosphonate complex in the near-infrared light absorbing composition is preferably in a range of 1 to 50% by mass, and more preferably in a range of 1 to 30% by mass. When the content is within this range, the dispersion is more stabilized.

### [Phosphate Ester]

The near-infrared light absorbing composition of the present invention contains the phosphate ester. The phosphate ester may be the copper complex.

The phosphate ester disperses the copper phosphonate complex in the near-infrared light absorbing composition and suppresses an increase in a particle size of particles formed of the copper phosphonate complex. Thus, visible light transmittance of the cured film of the near-infrared light absorbing composition is improved. In addition, since the near-infrared light absorbing composition contains the phosphate ester, the solubility of the antioxidant in the ether-based solvent is improved.

The phosphate ester can also be obtained as a commercial product. Commercially available products of the phosphate ester include, for example, the following.
1) Manufactured by DKS Co., Ltd.
   Plysurf A212C: polyoxyethylene tridecyl ether phosphate ester
   Plysurf A215C: polyoxyethylene tridecyl ether phosphate ester
   Plysurf A208F: polyoxyethylene alkyl (C8) ether phosphate ester
   Plysurf M208F: polyoxyethylene alkyl (C8) ether phosphate ester-monoethanolamine salts
   Plysurf A208N: polyoxyethylene alkyl (C12, 13) ether phosphate ester
   Plysurf A208B: polyoxyethylene lauryl ether phosphate ester (oil-based dispersant)
   Plysurf A210B: polyoxyethylene lauryl ether phosphate ester
   Plysurf A219B: polyoxyethylene lauryl ether phosphate ester (water-based dispersant)
   Plysurf DB-01: polyoxyethylene lauryl ether phosphate ester-monoethanolamine salt
   Plysurf AL: polyoxyethylenestyrenated phenyl ether phosphate ester and the like
2) Manufactured by Nikko Chemicals Co., Ltd.
   NIKKOL DDP-2: polyoxyethylene alkyl (C12 to C15) ether phosphate (2E.O. di (C12-15) pareth-2 phosphate)
   NIKKOL DDP-4: polyoxyethylene alkyl (C12 to C15) ether phosphate (4E.O. di (C12-15) pareth-4 phosphate)
   NIKKOL DDP-6: polyoxyethylene alkyl (C12 to C15) ether phosphate (6E.O. di (C12-15) pareth-6 phosphate)
   NIKKOL DDP-8: polyoxyethylene alkyl (C12 to C15) ether phosphate (8E.O. di (C12-15) pareth-8 phosphate)
   NIKKOL DDP-10: polyoxyethylene alkyl (C12 to C15) ether phosphate (10E.O. di (C12-15) pareth-10 phosphate)
   NIKKOL DLP-10: sodium polyoxyethylene lauryl ether phosphate (sodium dilaureth-10 phosphate)
   NIKKOL DOP-8NV: sodium polyoxyethylene oleyl ether phosphate (sodium dioleth-8 phosphate) and the like
3) Manufactured by ADEKA Corporation
   ADEKA COL TS-230E (aromatic phosphate ester)
   ADEKA COL CS-141E (aromatic phosphate ester)
   ADEKA COL CS1361E (aromatic phosphate ester)
   ADEKA COL CS-279 (aromatic phosphate ester)
   ADEKA COL PS-440E (aliphatic phosphate ester)
   ADEKA COL PS-810E (aliphatic phosphate ester)
   ADEKA COL PS-807 (aliphatic phosphate ester)
   ADEKA COL PS 984 (aliphatic phosphate ester) or the like

The phosphate ester preferably has a structure represented by the following General Formula (II) from the viewpoints of the dispersibility and dispersion stability of the copper phosphonate complex.

### [Chemical Formula 7]

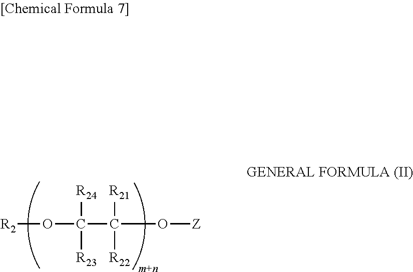

[In the General Formula (II), R₂ represents the alkyl group having 1 to 20 carbon atoms or the aryl group having 6 to 20 carbon atoms, and may further have the substituent group. R₂₁ to R₂₄ each independently represents a hydrogen atom or the alkyl group having 1 to 4 carbon atoms. m represents an average addition number of a partial structural unit in which all of R²¹ to R²⁴ are hydrogen atoms, and is in a range of 1 to 19. n represents an average addition number of a partial structural unit in which at least one of R²¹ to R₂₄ is the alkyl group having 1 to 4 carbon atoms, and is in a range of 1 to 19. m+n is the total number of m and n, and is in a range of 2 to 20. Z represents a structural unit selected from the following formula (Z-1) and formula (Z-2).]

### [Chemical Formula 8]

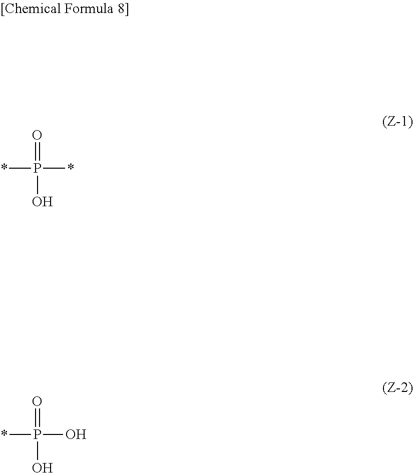 [SMILES: *P(*)(=O)O ; *P(=O)(O)O]

A partial structure in parentheses in the formula when all of R²¹ to R²⁴ are hydrogen atoms is referred to as an “ethylene oxide structure”. In the formula, m is the average addition number of the ethylene oxide structure.

A partial structure in parentheses in the formula in which at least one of R²¹ to R₂₄ is the alkyl group having 1 to 4 carbon atoms and the others are hydrogen atoms is referred to as an “alkyl-substituted ethylene oxide structure”. In the formula, n is the average addition number of the alkyl-substituted ethylene oxide structure.

The compound having the structure represented by the General Formula (II) has a high capability of forming a complex with copper and a high effect as a dispersant when both m and n are in the range of 1 to 19.

The compound having the structure represented by the General Formula (II) has an ethylene oxide structure and an alkyl-substituted ethylene oxide structure in combination, and therefore has many kinds of isomers. Thus, the compound increases entropy, and thus has a high effect as the dispersant.

In the compound having the structure represented by the General Formula (II), the influence of steric hindrance of the substituent group (R₂₁ to R₂₄) is suppressed, and the copper complex can form a finely dispersed state. Therefore, the respective effects of the ethylene oxide structure and the alkyl-substituted ethylene oxide structure are exhibited in a well-balanced manner, and the dispersibility and the dispersion stability of the near-infrared light absorbing composition can be made satisfactory.

In the General Formula (II), it is preferable that R₂ is the alkyl group having 6 to 16 carbon atoms, from the viewpoint of dispersibility of the copper complex and resistance to moist and heat.

The compound having a structure represented by General Formula (II) is a diester when Z is the formula (Z-1) and is a monoester when Z is the formula (Z-2).

A mixing ratio of the diester and the monoester is preferably such that a molar ratio of the monoester to a total amount of the diester and the monoester is within a range of 20 to 95%.

Specific examples of the compound having the structure represented by the General Formula (II) are shown in the following Tables I to V. The compound having the structure represented by the General Formula (II) according to the present invention is not limited thereto.

The Exemplary Compound in which both (Z-1) and (Z-2) are described in the column of “structure” of “Z” in Tables I to V are a mixture of the compound in which Z is the formula (Z-1) and the compound in which Z is the formula (Z-2).

TABLE I

| | R₂ | | | | | | | | | Z | | |
|---|---|---|---|---|---|---|---|---|---|---|---|---|
| | | NUMBER | ETHYLENE | | | | | | | | | MONOESTER |
| | | OF | OXIDE | | ALKYL-SUBSTITUTED ETHYLENE | | | | | | | MOLAR |
| | SUBSTITUENT | CARBON | STRUCTURE | | OXIDE STRUCTURE | | | | | STRUCTURE | | RATIO |
| No. | GROUP | ATOMS | m | R₂₁-R₂₄ | n | R₂₁ | R₂₂ | R₂₃ | R₂₄ | DIESTER | MONOESTER | [%] |
| 1 | METHYL | 1 | 5 | H | 5 | H | H | METHYL | H | Z-1 | Z-2 | 50 |
| 2 | METHYL | 1 | 19 | H | 5 | H | H | METHYL | H | Z-1 | Z-2 | 50 |
| 3 | METHYL | 1 | 5 | H | 5 | H | H | ETHYL | H | Z-1 | Z-2 | 50 |
| 4 | METHYL | 1 | 5 | H | 5 | H | H | METHYL | H | Z-1 | Z-2 | 70 |
| 5 | METHYL | 1 | 5 | H | 5 | H | H | ETHYL | H | Z-1 | Z-2 | 50 |
| 6 | METHYL | 1 | 10 | H | 5 | H | H | METHYL | H | Z-1 | Z-2 | 50 |
| 7 | ETHYL | 2 | 5 | H | 4 | H | H | METHYL | H | Z-1 | Z-2 | 50 |
| 8 | ETHYL | 2 | 19 | H | 3 | H | H | METHYL | H | Z-1 | Z-2 | 50 |
| 9 | ETHYL | 2 | 9 | H | 9 | H | H | H | METHYL | Z-1 | Z-2 | 30 |
| 10 | ETHYL | 2 | 8 | H | 8 | H | H | METHYL | H | Z-1 | Z-2 | 50 |
| 11 | ETHYL | 2 | 8 | H | 8 | METHYL | H | H | H | Z-1 | Z-2 | 50 |
| 12 | n-PROPYL | 3 | 3 | H | 3 | H | H | METHYL | H | Z-1 | Z-2 | 50 |
| 13 | n-PROPYL | 3 | 15 | H | 15 | H | H | METHYL | H | Z-1 | Z-2 | 50 |
| 14 | n-PROPYL | 3 | 1.5 | H | 3 | H | H | METHYL | H | Z-1 | Z-2 | 50 |
| 15 | n-PROPYL | 3 | 3 | H | 3 | H | H | METHYL | H | Z-1 | Z-2 | 70 |
| 16 | n-PROPYL | 3 | 3 | H | 3 | METHYL | H | METHYL | H | Z-1 | Z-2 | 50 |
| 17 | n-PROPYL | 3 | 5 | H | 5 | H | H | METHYL | H | Z-1 | Z-2 | 50 |
| 18 | ISOPROPYL | 3 | 3 | H | 3 | H | H | ETHYL | H | Z-1 | Z-2 | 50 |
| 19 | ISOPROPYL | 3 | 10 | H | 10 | H | H | ETHYL | H | Z-1 | Z-2 | 50 |
| 20 | ISOPROPYL | 3 | 2 | H | 1.5 | METHYL | H | METHYL | H | Z-1 | Z-2 | 20 |

TABLE II

| | R₂ | | | | | | | | | Z | | |
|---|---|---|---|---|---|---|---|---|---|---|---|---|
| | | NUMBER | ETHYLENE | | | | | | | | | MONOESTER |
| | | OF | OXIDE | | ALKYL-SUBSTITUTED ETHYLENE | | | | | | | MOLAR |
| | SUBSTITUENT | CARBON | STRUCTURE | | OXIDE STRUCTURE | | | | | STRUCTURE | | RATIO |
| No. | GROUP | ATOMS | m | R₂₁-R₂₄ | n | R₂₁ | R₂₂ | R₂₃ | R₂₄ | DIESTER | MONOESTER | [%] |
| 21 | ISOPROPYL | 3 | 5 | H | 5 | H | H | METHYL | H | Z-1 | Z-2 | 80 |
| 22 | n-BUTYL | 4 | 2 | H | 2 | H | H | METHYL | H | Z-1 | Z-2 | 50 |
| 23 | n-BUTYL | 4 | 1 | H | 1 | H | H | ETHYL | H | Z-1 | Z-2 | 30 |
| 24 | n-BUTYL | 4 | 1.5 | H | 1.5 | H | METHYL | H | H | Z-1 | Z-2 | 50 |
| 25 | n-BUTYL | 4 | 2 | H | 4 | H | H | ETHYL | H | Z-1 | Z-2 | 50 |
| 26 | n-BUTYL | 4 | 3 | H | 3 | ETHYL | H | H | H | Z-1 | Z-2 | 50 |
| 27 | ISOBUTYL | 4 | 3 | H | 3 | ETHYL | H | H | H | Z-1 | Z-2 | 50 |
| 28 | ISOBUTYL | 4 | 3 | H | 3 | H | H | METHYL | H | Z-1 | Z-2 | 60 |
| 29 | ISOBUTYL | 4 | 5 | H | 5 | H | H | METHYL | H | Z-1 | Z-2 | 50 |
| 30 | tert-BUTYL | 4 | 3 | H | 5 | H | H | METHYL | H | Z-1 | Z-2 | 50 |
| 31 | tert-BUTYL | 4 | 10 | H | 5 | H | H | METHYL | H | Z-1 | Z-2 | 30 |
| 32 | tert-BUTYL | 4 | 3 | H | 3 | H | H | METHYL | H | Z-1 | Z-2 | 50 |
| 33 | tert-BUTYL | 4 | 2 | H | 2 | H | H | METHYL | H | Z-1 | Z-2 | 50 |
| 34 | n-PENTYL | 5 | 3 | H | 3 | H | H | METHYL | H | Z-1 | Z-2 | 50 |
| 35 | n-PENTYL | 5 | 1 | H | 2 | H | H | METHYL | H | Z-1 | Z-2 | 50 |
| 36 | n-PENTYL | 5 | 4 | H | 4 | H | H | METHYL | H | Z-1 | Z-2 | 60 |
| 37 | ISOPENTYL | 5 | 4 | H | 4 | H | H | METHYL | H | Z-1 | Z-2 | 60 |
| 38 | ISOPENTYL | 5 | 4 | H | 4 | H | H | METHYL | H | Z-1 | Z-2 | 40 |
| 39 | ISOPENTYL | 5 | 8 | H | 8 | H | H | METHYL | H | Z-1 | Z-2 | 50 |
| 40 | ISOPENTYL | 5 | 2 | H | 2 | H | H | METHYL | H | Z-1 | Z-2 | 50 |

TABLE III

| | R₂ | | | | | | | | | Z | | |
|---|---|---|---|---|---|---|---|---|---|---|---|---|
| | | NUMBER | ETHYLENE | | | | | | | | | MONOESTER |
| | | OF | OXIDE | | ALKYL-SUBSTITUTED ETHYLENE | | | | | | | MOLAR |
| | SUBSTITUENT | CARBON | STRUCTURE | | OXIDE STRUCTURE | | | | | STRUCTURE | | RATIO |
| No. | GROUP | ATOMS | m | R₂₁-R₂₄ | n | R₂₁ | R₂₂ | R₂₃ | R₂₄ | DIESTER | MONOESTER | [%] |
| 41 | n-HEXYL | 6 | 2.5 | H | 2.5 | H | H | METHYL | H | Z-1 | Z-2 | 50 |
| 42 | n-HEXYL | 6 | 3 | H | 3 | H | H | METHYL | H | Z-1 | Z-2 | 60 |
| 43 | n-HEXYL | 6 | 3 | H | 1.5 | H | H | METHYL | H | Z-1 | Z-2 | 50 |
| 44 | n-HEXYL | 6 | 5 | H | 5 | METHYL | H | METHYL | H | Z-1 | Z-2 | 98 |
| 45 | n-HEXYL | 6 | 3 | H | 1 | H | H | METHYL | H | Z-1 | Z-2 | 70 |
| 46 | n-HEXYL | 6 | 1 | H | 1 | H | H | METHYL | H | Z-1 | Z-2 | 60 |
| 47 | n-HEXYL | 6 | 1 | H | 3 | H | H | METHYL | H | Z-1 | Z-2 | 50 |
| 48 | n-HEXYL | 6 | 2 | H | 1 | H | H | METHYL | H | Z-1 | Z-2 | 50 |
| 49 | ISOHEXYL | 6 | 3 | H | 3 | H | H | METHYL | H | Z-1 | Z-2 | 50 |
| 50 | ISOHEXYL | 6 | 5 | H | 5 | H | H | METHYL | H | Z-1 | Z-2 | 50 |
| 51 | ISOHEXYL | 6 | 2 | H | 2 | H | H | METHYL | H | Z-1 | Z-2 | 50 |
| 52 | n-OCTYL | 8 | 3 | H | 3 | H | H | METHYL | H | Z-1 | Z-2 | 40 |
| 53 | n-OCTYL | 8 | 2 | H | 2 | H | H | METHYL | H | Z-1 | Z-2 | 50 |
| 54 | n-OCTYL | 8 | 1 | H | 2 | H | H | METHYL | H | Z-1 | Z-2 | 50 |
| 55 | n-OCTYL | 8 | 5 | H | 5 | H | H | METHYL | H | Z-1 | Z-2 | 50 |
| 56 | n-OCTYL | 8 | 2 | H | 1 | H | H | METHYL | H | Z-1 | Z-2 | 60 |
| 57 | n-OCTYL | 8 | 1.5 | H | 1.5 | H | H | METHYL | H | Z-1 | Z-2 | 50 |
| 58 | 2-ETHYLHEXYL | 8 | 3 | H | 3 | H | H | METHYL | H | Z-1 | Z-2 | 50 |
| 59 | 2-ETHYLHEXYL | 8 | 2 | H | 2 | H | H | METHYL | H | Z-1 | Z-2 | 40 |
| 60 | 2-ETHYLHEXYL | 8 | 2.5 | H | 2.5 | H | H | METHYL | H | Z-1 | Z-2 | 50 |

TABLE IV

| | R₂ | | | | | | | | | Z | | |
|---|---|---|---|---|---|---|---|---|---|---|---|---|
| | | NUMBER | ETHYLENE | | | | | | | | | MONOESTER |
| | | OF | OXIDE | | ALKYL-SUBSTITUTED ETHYLENE | | | | | STRUCTURE | | MOLAR |
| | SUBSTITUENT | CARBON | STRUCTURE | | OXIDE STRUCTURE | | | | | | MONO- | RATIO |
| No. | GROUP | ATOMS | m | R₂₁-R₂₄ | n | R₂₁ | R₂₂ | R₂₃ | R₂₄ | DIESTER | ESTER | [%] |
| 61 | 2-ETHYLHEXYL | 8 | 1.5 | H | 1.5 | H | H | METHYL | H | Z-1 | Z-2 | 50 |
| 62 | 2-ETHYLHEXYL | 8 | 5 | H | 7 | METHYL | H | H | H | Z-1 | Z-2 | 30 |
| 63 | 2-ETHYLHEXYL | 8 | 2 | H | 2 | H | H | METHYL | H | Z-1 | Z-2 | 50 |
| 64 | ISOOCTYL | 8 | 2.5 | H | 2.5 | H | H | METHYL | H | Z-1 | Z-2 | 40 |
| 65 | ISOOCTYL | 8 | 5 | H | 5 | METHYL | H | METHYL | H | Z-1 | Z-2 | 18 |
| 66 | ISOOCTYL | 8 | 1.5 | H | 1.5 | H | H | METHYL | H | Z-1 | Z-2 | 50 |
| 67 | ISOOCTYL | 8 | 2 | H | 3 | H | H | METHYL | H | Z-1 | Z-2 | 50 |
| 68 | n-DECYL | 10 | 1.5 | H | 1.5 | METHYL | H | METHYL | H | Z-1 | Z-2 | 50 |
| 69 | n-DECYL | 10 | 3 | H | 3 | H | H | METHYL | H | Z-1 | Z-2 | 50 |
| 70 | n-DECYL | 10 | 1.5 | H | 1.5 | H | H | ETHYL | H | Z-1 | Z-2 | 50 |
| 71 | n-DECYL | 10 | 2 | H | 5 | METHYL | METHYL | H | H | Z-1 | Z-2 | 95 |
| 72 | ISODECYL | 10 | 5 | H | 5 | H | H | METHYL | H | Z-1 | Z-2 | 50 |
| 73 | ISODECYL | 10 | 3 | H | 3 | H | H | METHYL | H | Z-1 | Z-2 | 50 |
| 74 | ISODECYL | 10 | 2 | H | 2 | H | H | METHYL | H | Z-1 | Z-2 | 50 |
| 75 | n-DODECYL | 12 | 1.5 | H | 1.5 | H | H | METHYL | H | Z-1 | Z-2 | 50 |
| 76 | n-DODECYL | 12 | 2 | H | 2 | H | H | METHYL | H | Z-1 | Z-2 | 60 |
| 77 | n-DODECYL | 12 | 3 | H | 3 | H | H | METHYL | H | Z-1 | Z-2 | 50 |
| 78 | n-DODECYL | 12 | 1.5 | H | 1.5 | H | H | METHYL | H | Z-1 | Z-2 | 60 |
| 79 | n-DODECYL | 12 | 2 | H | 2 | H | H | METHYL | H | Z-1 | Z-2 | 50 |
| 80 | n-DODECYL | 12 | 3 | H | 3 | H | H | METHYL | H | Z-1 | Z-2 | 50 |

TABLE V

| | R₂ | | | | | | | | | Z | | |
|---|---|---|---|---|---|---|---|---|---|---|---|---|
| | | NUMBER | ETHYLENE | | | | | | | | | MONOESTER |
| | | OF | OXIDE | | ALKYL-SUBSTITUTED ETHYLENE | | | | | | | MOLAR |
| | SUBSTITUENT | CARBON | STRUCTURE | | OXIDE STRUCTURE | | | | | STRUCTURE | | RATIO |
| No. | GROUP | ATOMS | m | R₂₁-R₂₄ | n | R₂₁ | R₂₂ | R₂₃ | R₂₄ | DIESTER | MONOESTER | [%] |
| 81 | n-DODECYL | 12 | 2 | H | 2 | H | H | METHYL | H | Z-1 | Z-2 | 60 |
| 82 | 2-BUTYLOCTYL | 12 | 5 | H | 3 | H | H | METHYL | H | Z-1 | Z-2 | 50 |
| 83 | 2-BUTYLOCTYL | 12 | 1.5 | H | 1.5 | H | H | METHYL | H | Z-1 | Z-2 | 50 |
| 84 | 2-BUTYLOCTYL | 12 | 1.5 | H | 1.5 | H | METHYL | H | H | Z-1 | Z-2 | 60 |
| 85 | 2-BUTYLOCTYL | 12 | 1 | H | 3 | H | H | METHYL | H | Z-1 | Z-2 | 50 |
| 86 | 2-HEXYLOCTYL | 14 | 1 | H | 1.5 | H | H | METHYL | H | Z-1 | Z-2 | 30 |
| 87 | 2-HEXYLOCTYL | 14 | 2 | H | 3 | H | H | METHYL | H | Z-1 | Z-2 | 50 |
| 88 | n-PENTADECYL | 15 | 1.5 | H | 1.5 | H | H | METHYL | H | Z-1 | Z-2 | 50 |
| 89 | n-PENTADECYL | 15 | 3 | H | 2 | H | H | METHYL | H | Z-1 | Z-2 | 50 |
| 90 | n-STEARYL | 16 | 3 | H | 3 | H | H | METHYL | H | Z-1 | Z-2 | 70 |
| 91 | n-STEARYL | 16 | 1.5 | H | 2.5 | H | H | METHYL | H | Z-1 | Z-2 | 50 |
| 92 | n-STEARYL | 16 | 3 | H | 3 | H | H | METHYL | H | Z-1 | Z-2 | 60 |
| 93 | n-STEARYL | 16 | 3 | H | 3 | H | H | METHYL | H | Z-1 | Z-2 | 50 |
| 94 | OCTADECYL | 18 | 1.5 | H | 1.5 | H | H | METHYL | H | Z-1 | Z-2 | 50 |
| 95 | PHENYL | 6 | 5 | H | 5 | H | H | METHYL | H | Z-1 | Z-2 | 50 |
| 96 | PHENYL | 6 | 3 | H | 3 | H | H | METHYL | H | Z-1 | Z-2 | 50 |
| 97 | PHENYL | 12 | 1 | H | 1 | H | H | METHYL | H | Z-1 | Z-2 | 50 |
| 98 | XYLYL | 12 | 3 | H | 4 | H | H | METHYL | H | Z-1 | Z-2 | 50 |
| 99 | n-OCTYL | 8 | 3 | H | 0 | — | — | — | — | Z-1 | Z-2 | 50 |
| 100 | n-DODECYL | 12 | 0 | — | 3 | H | H | METHYL | H | Z-1 | Z-2 | 50 |

Exemplary Compound 1 will be specifically described. The Exemplary Compound 1 is the mixture of the compound (diester) in which Z is the formula (Z-1) and the compound (monoester) in which Z is the formula (Z-2).

The compound (monoester) in which Z is the formula (Z-2) is represented by, for example, the structure of the following exemplary compound 1-1. The compound (diester) in which Z is the formula (Z-1) is represented by, for example, the structure of the following exemplary compound 1-2.

### [Chemical Formula 9]

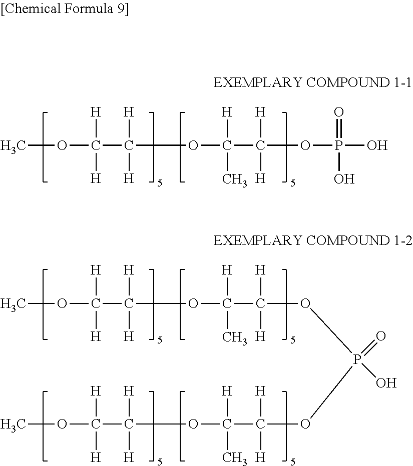

In the Exemplary Compound 1, the molar ratio of the compound (monoester) in which Z is the formula (Z-2) is 50%, and the Exemplary Compound 1-1 and the Exemplary Compound 1-2 are contained in the same molar amounts.

Each of m and n is the average addition number. Therefore, even in Exemplary Compound 1 in which m is 5 and n is 5, the number of ethylene oxide structures in one molecule is not necessarily five, and the number of alkyl-substituted ethylene oxide structures is not necessarily five.

The compound having the structure represented by the General Formula (II) can be synthesized, for example, with reference to the method described in Japanese Unexamined Patent Publication No. 2005-255608, Japanese Unexamined Patent Publication No. 2015-000396, Japanese Unexamined Patent Publication No. 2015-000970, Japanese Unexamined Patent Publication No. 2015-178072, Japanese Unexamined Patent Publication No. 2015-178073, Japanese Patent No. 4422866 or the like.

Hereinafter, some of the methods for synthesizing the Exemplary Compound described in the tables will be specifically described. Note that the method for synthesizing the compound having the structure represented by the General Formula (II) is not limited to the following synthesis methods.

### (Method of Synthesizing Exemplary Compound 53)

n-Octanol [130 g (1.0 mol)] is placed in an autoclave. To this is added propylene oxide [116 g (2.0 mol)] using potassium hydroxide as m catalyst under conditions of a pressure of 147 kPa and a temperature of 130° C. Thereafter, ethyleneoxide [88 g (2.0 mol)] is further added thereto. Next, after confirming that no n-octanol remains, the above adduct is taken into a reactor. With this, using a toluene solution, phosphoric anhydride [47 g (0.33 mol)] is reacted at 80° C. for 5 hours. A reaction product is washed with distilled water, and the solvent is distilled under reduced pressure. Thus, Exemplary Compound 53 shown below can be obtained.

### [Chemical Formula 10]

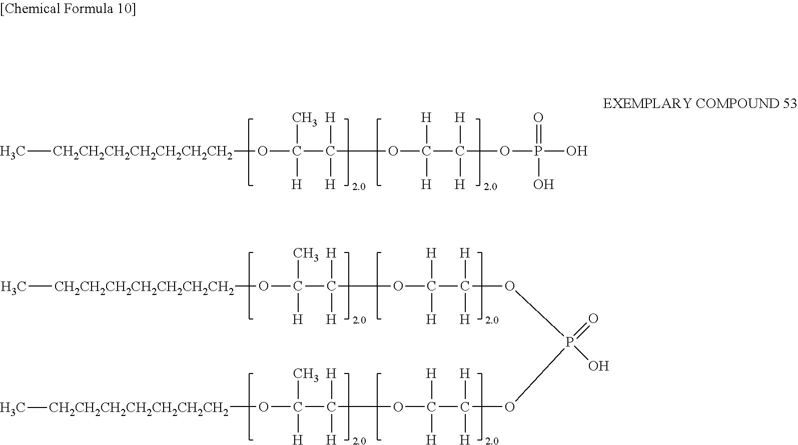

### (Method of Synthesizing Exemplary Compound 54)

n-Octanol [130 g (1.0 mol)] is placed in the autoclave. To this is added the propylene oxide [116 g (2.0 mol)] using the potassium hydroxide as the m catalyst under the conditions of the pressure of 147 kPa and the temperature of 130° C. Thereafter, the ethyleneoxide [44 g (1.0 mol)] is further added thereto. Next, after confirming that no n-octanol remains, the above adduct is taken into the reactor. With this, using the toluene solution, the phosphoric anhydride [47 g (0.33 mol)] is reacted at 80° C. for 5 hours. The reaction product is washed with the distilled water, and the solvent is distilled under the reduced pressure. Thus, Exemplary Compound 54 shown below can be obtained.

### [Chemical Formula 11]

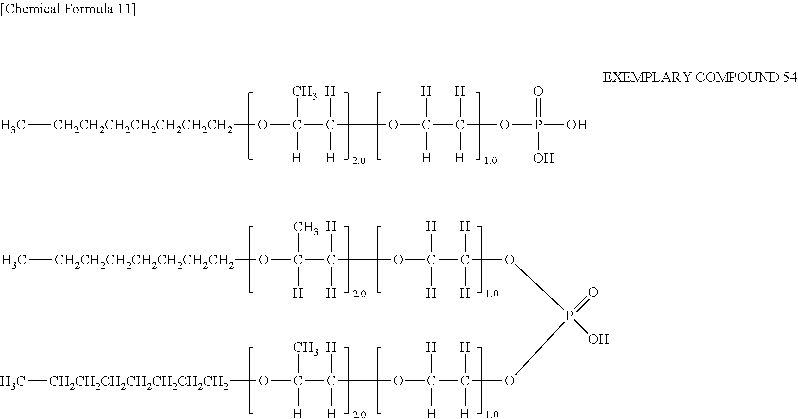

### (Method of Synthesizing Exemplary Compound 60)

2-Ethylhexanol [130 g (1.0 mol)] is placed in the autoclave. To this is added the propylene oxide [145 g (2.5 mol)] using the potassium hydroxide as the m catalyst under the conditions of the pressure of 147 kPa and the temperature of 130° C. Thereafter, the ethyleneoxide [110 g (2.5 mol)] is further added thereto. Next, after confirming that no 2-ethylhexanol remains, the above adduct is taken into the reactor. With this, using the toluene solution, the phosphoric anhydride [47 g (0.33 mol)] is reacted at 80° C. for 5 hours. The reaction product is washed with the distilled water, and the solvent is distilled under the reduced pressure. Thus, Exemplary Compound 60 shown below can be obtained.

### [Chemical Formula 12]

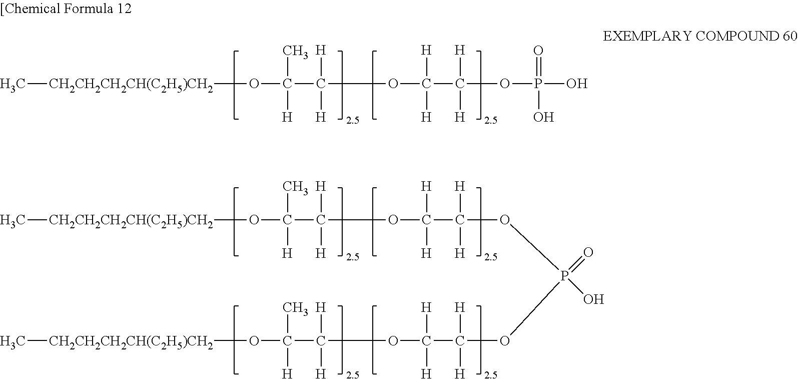

### (Method of Synthesizing Exemplary Compound 61)

2-Ethylhexanol [130 g (1.0 mol)] is placed in the autoclave. To this is added the propylene oxide [87 g (1.5 mol)] using the potassium hydroxide as the m catalyst under the conditions of the pressure of 147 kPa and the temperature of 130° C. Thereafter, the ethyleneoxide [66 g (1.5 mol)] is further added thereto. Next, after confirming that no 2-ethylhexanol remains, the above adduct is taken into the reactor. With this, using the toluene solution, the phosphoric anhydride [47 g (0.33 mol)] is reacted at 80° C. for 5 hours. The reaction product is washed with the distilled water, and the solvent is distilled under the reduced pressure. Thus, Exemplary Compound 61 shown below can be obtained.

### [Chemical Formula 13]

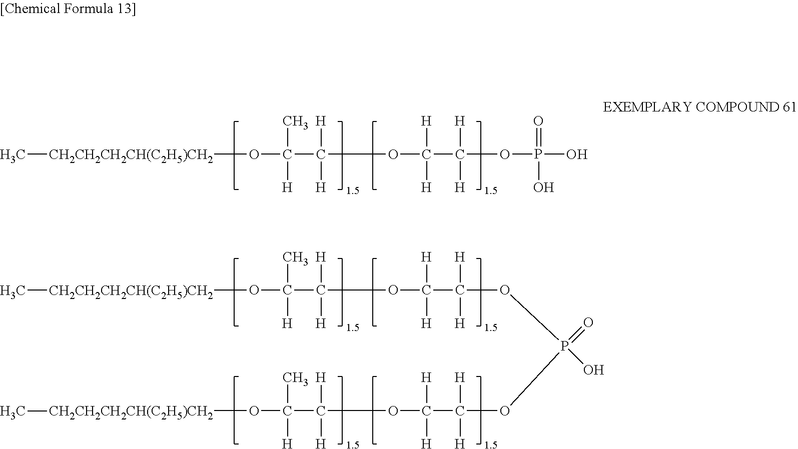

The content of the phosphate ester in the near-infrared light absorbing composition is preferably in a range of 0.5% by mass to 20% by mass and more preferably in a range of 1% by mass to 10% by mass. When the content is within this range, both the dispersion stability and the moist/heat resistance can be more satisfactorily achieved.

### [Solvent]

The near-infrared light absorbing composition of the present invention contains the solvent and is characterized by containing at least the ether-based solvent as the solvent.

When the ether-based solvent is contained, the dispersibility of other components becomes satisfactory. Thus, the copper complex is easily formed, and the visible light transmittance of the cured film of the near-infrared light absorbing composition is improved.

Examples of the ether-based solvents include anisole, diethyl ether, dibutyl ether, di-isopropyl ether, tetrahydrofuran, 1,4-dioxane, 2,3-dimethyl-1,4-dioxane, ethylene glycol monomethyl ether, 2-propylene glycol monomethyl ether cyclopentyl methyl ether, 4-methyltetrahydropyran, 2-methyltetrahydrofuran, and the like.

The ether-based solvent preferably has a cycloalkyl group or a cycloether group from the viewpoint of dispersibility of other components. As the cycloalkyl group, a cyclopentyl group and a cyclohexyl group are preferable. As the cycloether group, a tetrahydrofuran group and a tetrapyran group are preferable.

Structures of the ether-based solvents suitable for the present invention are illustrated below.

### [Chemical Formula 14]

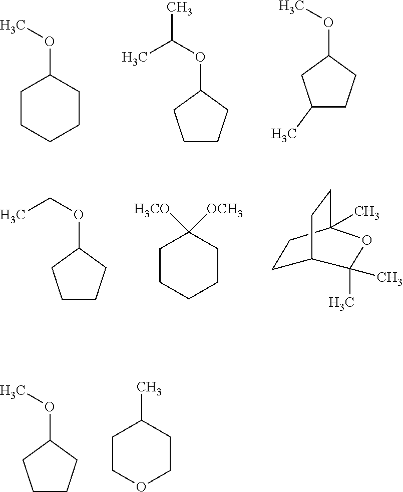

The near-infrared light absorbing composition according to the present invention may contain the solvent other than the ether-based solvent, to the extent that the effect of the present invention is not inhibited.

Examples of the solvents other than the ether-based solvents include hexane, heptane, cyclohexane, methylcyclohexane, methanol, ethanol, n-propanol, ethylene glycol, acetone, methyl ethyl ketone, toluene, xylene, mesitylene, cyclohexylbenzene, isopropylbiphenyl, methylene chloride, 1,1,2-trichloroethane, chloroform, 2-ethylhexane, 2-pentanol, sec-butylbenzene, 2-methylcyclohexylbenzene and the like.

The content of the solvent in the near-infrared light absorbing composition is preferably in a range of 61% by mass to 98% by mass, and more preferably in a range of 70% by mass to 95% by mass. When the content is within this range, dispersion stability can be maintained and more satisfactory long-term storage is enabled.

### [Antioxidant]

The near-infrared light absorbing composition of the present invention is characterized by containing at least one type selected from a phenol-based antioxidant having a structure represented by the following General Formula (1), an amine-based antioxidant having a structure represented by the following General Formula (2), a phosphorus-based antioxidant having a structure represented by the following General Formula (3) or (4), and a sulfur-based antioxidant having a structure represented by the following General Formula (5).

### [Chemical Formula 15]

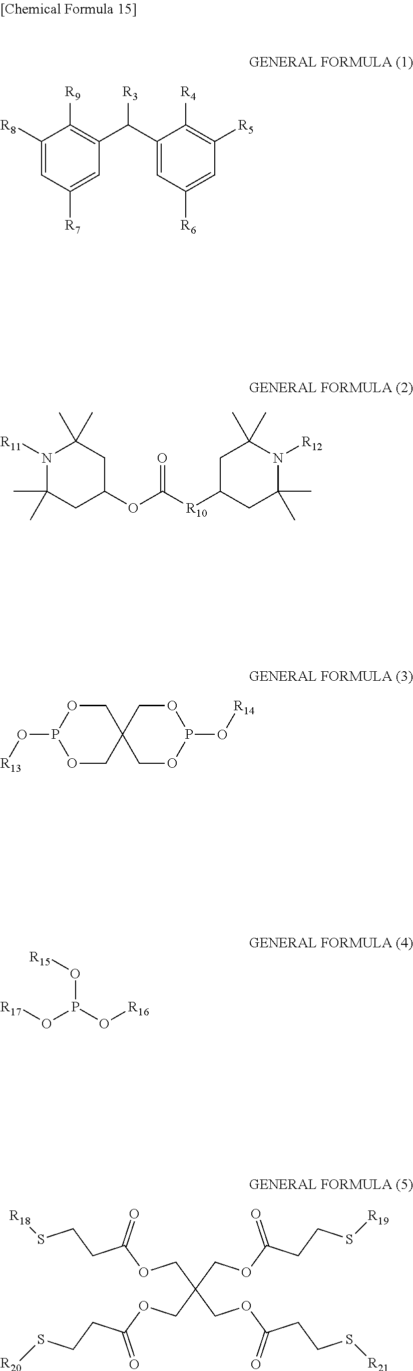

[In the General Formulas (1) to (5), R₃ is the alkyl group having 1 to 4 carbon atoms. R₄ to R₉ are substituent groups selected from a hydroxy group, an acyloxy group, and the alkyl group. At least one among R₄ to R₉ is the hydroxy group, and at least one of the others is the acyloxy group. R₁₀ is oxygen or the alkylene ester group having 1 to 20 carbon atoms, and may further have a substituent group. R₁₁ and R¹² are hydrogen, the alkyl group having 1 to 20, or an alkoxy group having 1 to 20 carbon atoms. R₁₃ to R²¹ are the alkyl group or an aryl group having 1 to 20 carbon atoms, and may further have the substituent group. R₁₅ and R₁₆ may be bonded to each other.]

The alkylene ester group is a divalent linking group represented by the following structural formula. In the structural formulas, * represents a bonding site.

*—(CH₂)ₙ—COO—*

The antioxidant prevents oxidation of the ether-based solvent and contributes to a reduction in the risk of explosion. In addition, when the antioxidant is used in combination with the ether-based solvent, the antioxidant also contributes to improvement in dispersibility and dispersion stability of the copper phosphonate complex.

The near-infrared light absorbing composition of the present invention preferably contains at least one type selected from the phenol-based antioxidant and the amine-based antioxidant. The phenol-based antioxidant or the amine-based antioxidant functions as a radical chain inhibitor. In addition, when the antioxidant forms the copper complex, there is a possibility that the copper complex precipitates to adversely affect the optical characteristic and the like of the cured film. However, since the phenol-based antioxidant and the amine-based antioxidant are unlikely to form the copper complex, they are also preferable in that they are unlikely to have an adverse effect on the optical characteristic and the like of the cured film.

From the viewpoint of suppressing an increase in the peroxide, the near-infrared light absorbing composition of the present invention more preferably contains at least one type selected from the phenol-based antioxidant and the amine-based antioxidant, and at least one type selected from the phosphorus-based antioxidant and the sulfur-based antioxidant. The phenol-based antioxidant or the amine-based antioxidant functions as the radical chain inhibitor. The phosphorus-based antioxidant or the sulfur-based antioxidant function as the peroxide decomposer. By using these in combination, an increase in the peroxide can be effectively suppressed.

The antioxidants having the structures represented by the General Formulas (1) to (5) are exemplified below.

### (Example Of Phenolic Antioxidant Having Structure Represented By General Formula (1))

### [Chemical Formula 16]

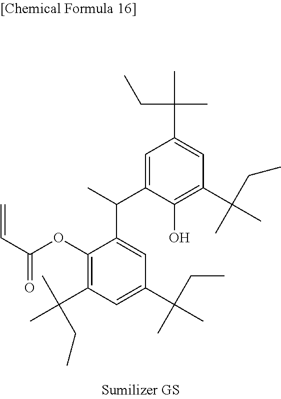 [SMILES: C=CC(=O)Oc1c(C(C)c2cc(C(C)(C)CC)cc(C(C)(C)CC)c2O)cc(C(C)(C)CC)cc1C(C)(C)CC]

### (Example Of Amine-Based Antioxidant Having Structure Represented By General Formula (2))

### [Chemical Formula 17]

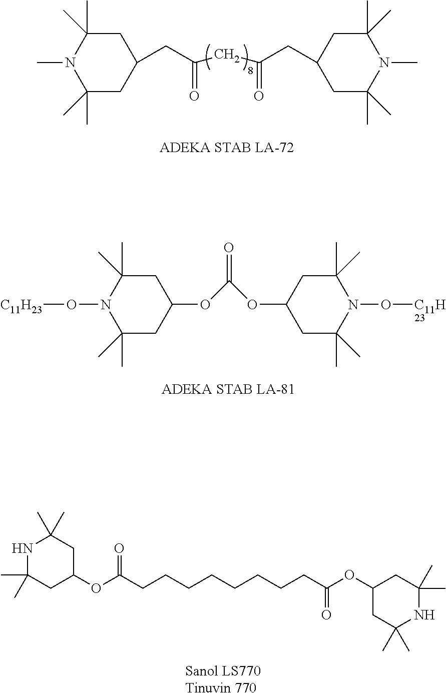

### (Example Of Phosphorus-Based Antioxidant Having Structure Represented By General Formula (3) Or (4))

### [Chemical Formula 18]

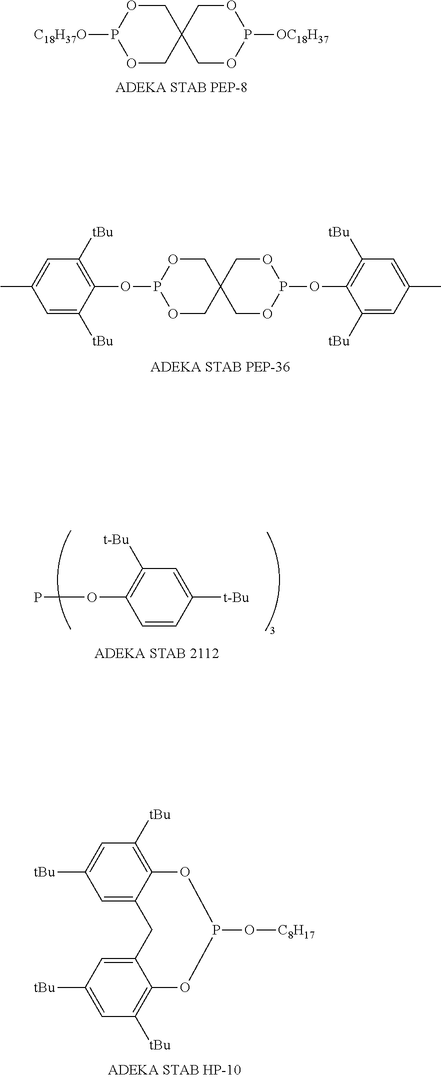

### (Example Of Sulfur-Based Antioxidant Having Structure Represented By General Formula (5))

### [Chemical Formula 19]

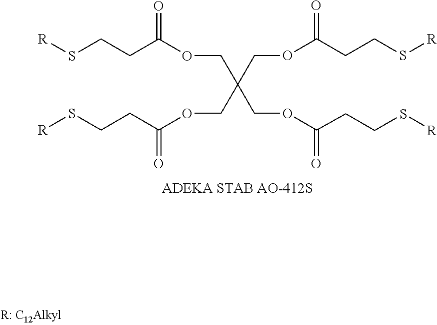

The antioxidants not having the structures represented by the General Formulas (1) to (5) are illustrated below for reference. In a case of using these antioxidants, the cured product of the near-infrared light absorbing composition is likely to be colored.

### (Example Of Phenolic Antioxidant Not Having Structure Represented By General Formula (1))

### [Chemical Formula 20]

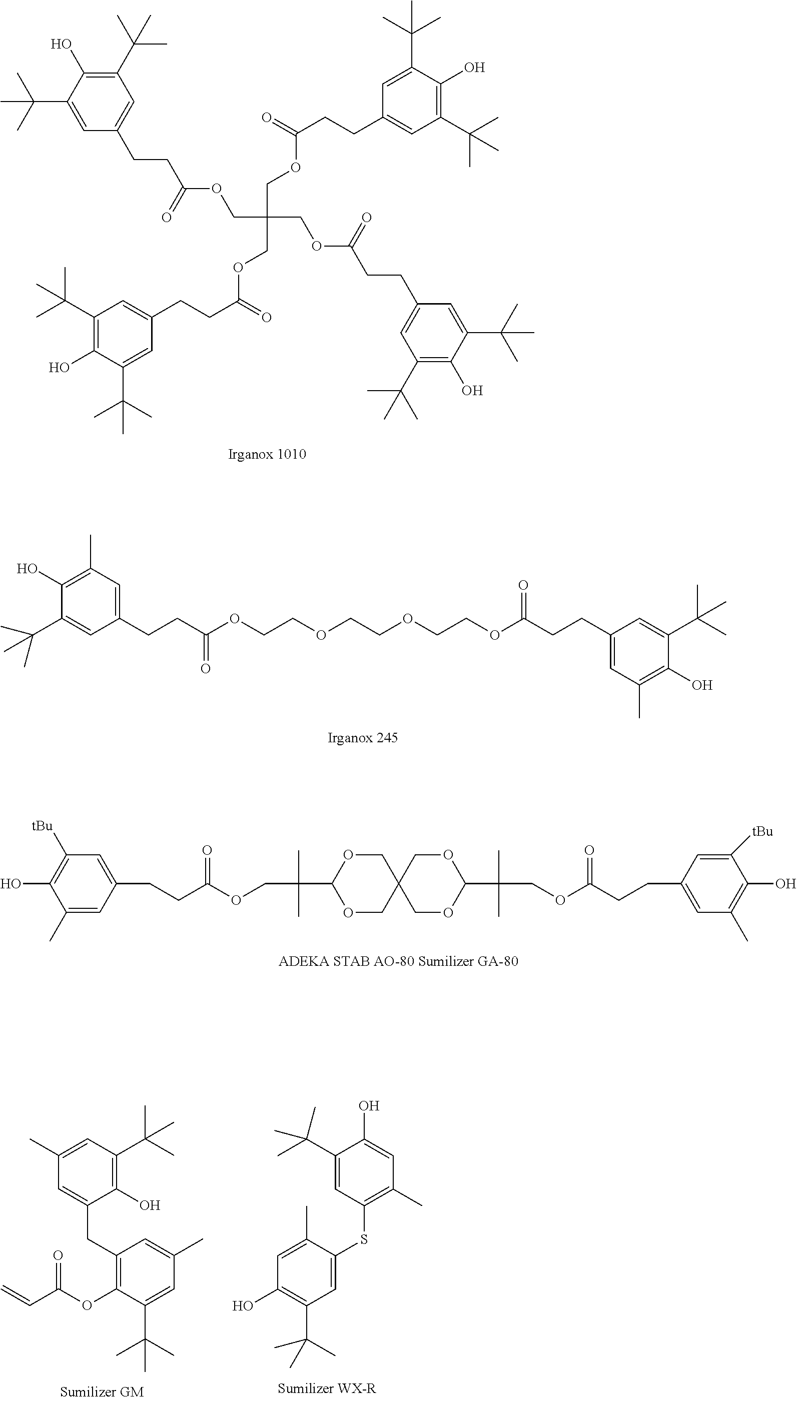

### (Example Of Phosphorus-Based Antioxidant Not Having Structure Represented By General Formula (3) Or (4))

### [Chemical Formula 21]

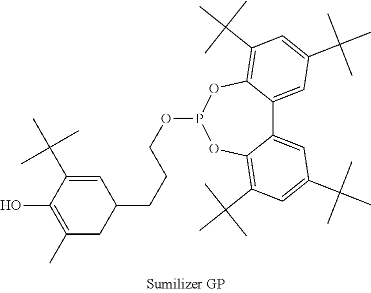 [SMILES: CC1=C(O)C(C(C)(C)C)=CC(CCCOp2oc3c(C(C)(C)C)cc(C(C)(C)C)cc3c3cc(C(C)(C)C)cc(C(C)(C)C)c3o2)C1]

The above-mentioned antioxidants are manufactured by the following sources.
Sumilizer series: Sumitomo Chemical Co., Ltd
Adeka STAB series: ADEKA Corporation
Sanol series: Sankyo Company
Tinuvin series: Basf SE
Irganox series: Basf SE

The total content of the antioxidant in the near-infrared light absorbing composition is preferably in a range of 0.001 to 6% by mass, and more preferably in a range of 0.005 to 3% by mass. When the content is within this range, an antioxidant function of the ether-based solvent can be appropriately exhibited.

### [Titanium Coupling Agent]

The near-infrared light absorbing composition according to the present invention preferably contains a titanium coupling agent. Thus, a dispersion stability of the copper phosphonate complex is improved, and therefore, the haze of the cured film formed from the near-infrared light absorbing composition decreases, and the visible light transmittance becomes satisfactory. In addition, due to formation of the film of the titanium coupling agent by the crosslinking reaction of the titanium coupling agent, the penetration of the water from the film surface can be suppressed, and the moisture resistance of the cured film is improved. In addition, since the titanium coupling agent film also blocks oxygen, generation of the peroxide derived from the ether-based solvent can be suppressed. In addition, due to the physical adsorption or the crosslinking between the titanium coupling agent and the copper phosphonate complex, thermal vibration of the copper phosphonate complex is suppressed, and the heat resistance of the cured film is improved.

The titanium coupling agent is preferably a compound having a structure represented by the following General Formula (III) or (IV).

(R₃O)₄₋ₘTi(O—R₄—OH)ₘ General Formula (III)

(R₃O)₄₋ₘTi(OCOR₅)ₘ General Formula (IV)

[In the General Formulas (III) and (IV), m is an integer of 1 to 4. R₃ and R₅ are each the independent alkyl group having 1 to 30 carbon atoms, and may further have the substituent group. R₄ is the alkylene group having 1 to carbon atoms, and may further have the substituent group.]

The alkyl group having 1 to 30 carbon atoms represented by R₃ and R₅ may be linear or branched. Examples of the alkyl group include a methyl group, an ethyl group, an n-propyl group, an isopropyl group, an n-butyl group, a tert-butyl group, an n-hexyl group, a 2-ethylhexyl group, an n-octyl group, a 2-butyloctyl group, a 2-hexyloctyl group, an n-decyl group, a 2-hexyldecyl group, an n-dodecyl group, and an n-stearyl group. Each alkyl group may further have a substituent group. The number of carbon atoms of the alkyl group is preferably 6 to 20.

The alkylene group having 1 to 30 carbon atoms represented by R₄ may be straight-chain or branched. An example of the alkylene group includes methylene group, ethylene group, n-propylene group, isopropylene group, n-butylene group, tert-butylene group, n-hexylene group, 2-ethylhexylene group, n-octylene group, 2-butyl octylene group, 2-hexyl octylene group, n-decylene group, 2-hexyldecylene group, n-dodecylene group, n-stearylene group, 1-propyl-2-ethyl-propylene group and the like. Each alkylene group may further have a substituent group. The carbon number of the alkylene group is preferably 6 to 20.

Examples of the substituent group that R₃ to R₅ may each have include alkoxy group (e.g., methoxy group, ethoxy group etc), a halogen atom (e.g., a fluorine atom), cyano group, nitro group, dialkylamino group (e.g., dimethylamino group, etc), trialkylsilyl group (e.g., trimethylsilyl group and the like), triarylsilyl group (e.g., triphenylsilyl group etc), triheteroarylsilyl group (e.g., tripyridylsilyl group etc), benzyl group, aryl group (e.g., phenyl group etc), heteroaryl group (e.g., pyridyl group, carbazolyl group and the like), trifluoromethyl group and the like, and as a fused ring, there are 9,9′-dimethylfluorene, carbazole, dibenzofuran and the like.

Examples of the compound having a structure represented by the General Formula (III) include titanium alkylene glycolate.

Specific examples of the compound having the structure represented by General Formula (III) are set forth below. The compound having the structure represented by the General Formula (III) according to the present invention is not limited thereto.

### [Chemical Formula 22]

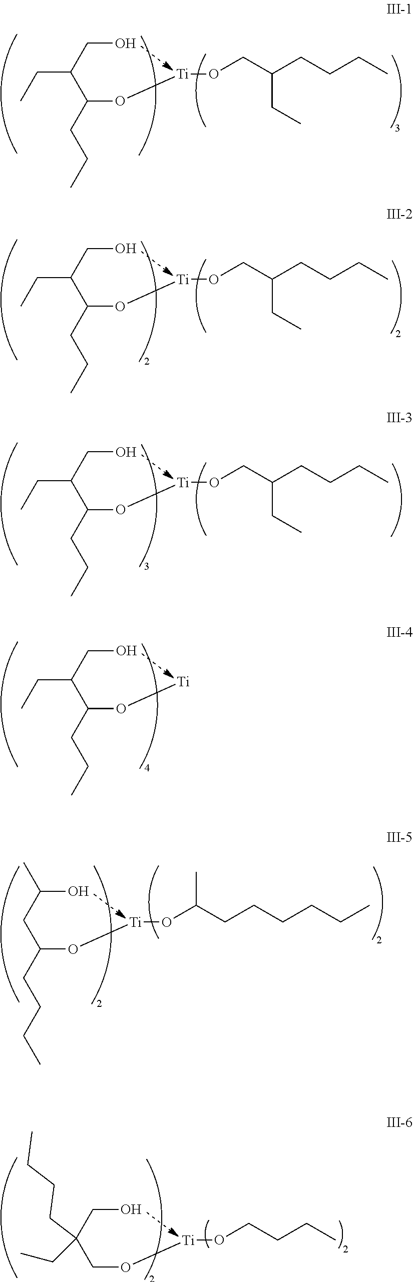

### [Chemical Formula 23]

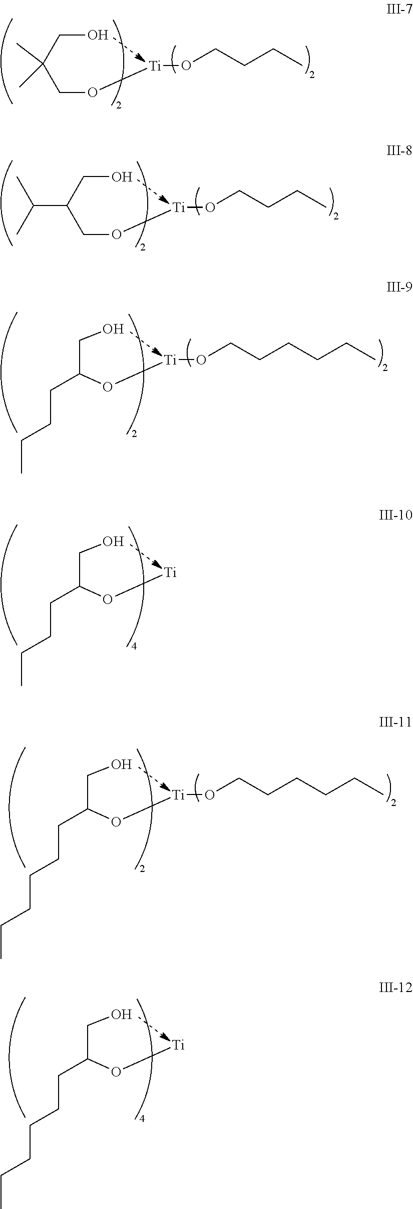

The compound having the structure represented by the General Formula (III) is also available as a commercial product. Examples of the commercial product include Orgatics TC-245 (manufactured by Matsumoto Fine Chemical Co., Ltd).

Examples of the compound having a structure represented by the General Formula (IV) include titanium isostearate and polyhydroxy titanium stearate.

Specific examples of the compound having the structure represented by General Formula (IV) are set forth below. The compound having the structure represented by General Formula (IV) according to the present invention is not limited thereto.

### [Chemical Formula 24]

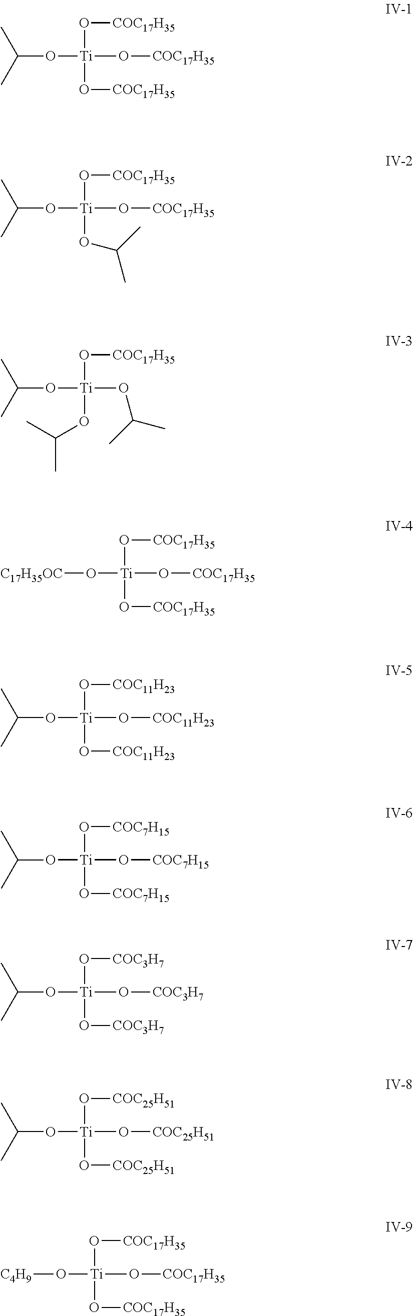

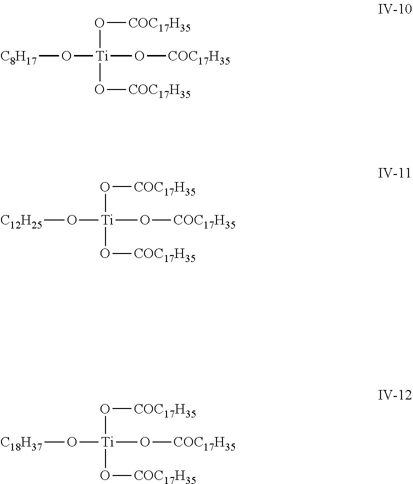

The compound having the structure represented by the General Formula (IV) is also available as the commercial product. Examples of the commercial product include Orgatics TC-800, Orgatics ZC-200, and Orgatics ZC-320 (all manufactured by Matsumoto Fine Chemical Co., Ltd), TBSTA, DPSTA-25, S-151, S-152, S-181, and TBP (all manufactured by Nippon Soda Co., Ltd), and Plenact TTS (manufactured by Ajinomoto Fine-Techno Co., Inc).

The compound having a structure represented by the above General Formula (III) or (IV) can also be obtained with reference to, for example, a synthesis method described in Japanese Unexamined Patent Publication No. 2011-219704.

The content of the titanium coupling agent in the near-infrared light absorbing composition is preferably in a range of 0.05 to 10% by mass, and more preferably in a range of 0.1 to 1% by mass. When the content is within this range, the dispersion stability of the dispersion liquid, moisture/heat resistance of the cured film, and the heat resistance of the cured film can be improved in a balanced manner.

### [Acetate Ion Concentration]

The near-infrared light absorbing composition of the present invention preferably has an acetate ion concentration of 0.5% by mass or less. A near-infrared light absorbing composition containing a copper complex generally uses copper acetate at the time of preparation. Therefore, the near-infrared light absorbing composition often contains acetate ions. However, the acetate ion reduces the dispersion stability of the copper phosphonate complex and also inhibits the function of the antioxidant. Therefore, the acetate ion concentration is preferably low. Specifically, when the acetate ion concentration is 0.5% by mass or less, it is possible to suppress a reduction in the dispersion stability of the copper phosphonate complex and inhibition of the function of the antioxidant.

The acetate ion concentration can be measured by the following sequence. The near-infrared light absorbing composition [about 2 g] and ultrapure water [2.5 mL] are mixed and shaken for 10 minutes. This is centrifuged and an aqueous phase is removed. The acetate ion concentration of the extracted aqueous phase is measured using an organic acid migration liquid and a capillary electrophoresis apparatus.

The acetate ion concentration in the near-infrared light absorbing composition can be reduced by an azeotropic treatment. Specifically, the acetate ion concentration in the near-infrared light absorbing composition can be reduced by subjecting the near-infrared light absorbing composition to the azeotropic treatment with, for example, methylcyclohexane, toluene or the like as an azeotropic solvent.

### [Other Components]

The near-infrared light absorbing composition of the present invention may contain other components to the extent that the effects of the present invention are not inhibited. Examples of the other components include a sensitizer, a crosslinking agent, a curing accelerator, a filler, a thermal curing accelerator, a thermal polymerization inhibitor, a plasticizer, conductive particles, a filling agent, a defoaming agent, a flame retardant, a leveling agent, a peeling accelerator, a fragrance, a surface tension modifier, and a chain transfer agent.

For these components, for example, the contents described in paragraphs to of Japanese Unexamined Patent Publication No. 2012-003225, paragraphs to of Japanese Unexamined Patent Publication No. 2008-250074, paragraphs [0103] to [0104] of Japanese Unexamined Patent Publication No. 2008-250074, paragraphs to of Japanese Unexamined Patent Publication No. 2008-250074, and the like can be referred to.

### [Near-Infrared Light Absorbing Cured Film]

The near-infrared light absorbing composition of the present invention can be used for forming a near-infrared light absorbing cured film.

The near-infrared light absorbing cured film can be formed, for example, by the following sequence. An application liquid in which a near-infrared light absorbing composition and a curable resin are mixed is prepared. The application liquid is applied onto the substrate by a wet coating method such as spin coating and a dispenser to form a coating film. The coating film is cured by a predetermined heating treatment. Thus, the near-infrared light absorbing cured film can be formed.

The film thickness of the near-infrared light absorbing cured film is preferably in a range of 10 to 500 μm, and more preferably in a range of 10 to 300 μm.

The film thickness of the near-infrared light absorbing cured film can be measured using, for example, a film thickness meter in which the following devices are combined.
Terminal: DIGIMICRO MH-15M (manufactured by NIKON)
Stand: DIGIMICRO STAND MS-5C (manufactured by NIKON)
Reader: DIGITAL READ OUT TC-101A (manufactured by NIKON)

It is preferable that the curable resin used in the formation of the near-infrared light absorbing cured film has optical transparency to visible light and near-infrared light, and is capable of dispersing the fine particles in the near-infrared light absorbing composition.

The copper phosphonate complex is a substance having a relatively low polarity and is well dispersed in a hydrophobic material. Therefore, a curability resin is preferably a resin (silicone) having a polysiloxane structure or a resin having an acrylic group, an epoxy group, or a phenyl group.

Among these, a resin having the polysiloxane structure is particularly preferable because it is less likely to be thermally decomposed, has high light transmittance with respect to visible light and near-infrared light, and has high heat resistance.

Specific examples of resin having the polysiloxane structure include KR-255, KR-300, KR-2621-1, KR-211, KR-311, KR-216, KR-212, and KR-251 manufactured by Shin-Etsu Chemical Co., Ltd, and SS-6203, SS-6309, VS-9301, and VS-9506 manufactured by Sanyu Rec Co., Ltd.

From the viewpoint of low gas permeability and moisture resistance, it is also preferable to use a matrix resin having the epoxy group as the curability resin.

Specific examples of resins having an epoxy group include KJC-X5 (manufactured by Shin-Etsu Chemical Co., Ltd), NLD-L-672 (manufactured by Sanyu Rec Co., Ltd), LE-1421 (manufactured by Sanyu Rec Co., Ltd), and EpiFine series (manufactured by KISCO Inc).

It is also preferable to use a resin having both the polysiloxane structure and the epoxy group as the curability resin. The resin exhibits high heat resistance and moisture resistance, and therefore has properties suitable as a material for an image sensor for the solid state imaging device.

Specific example of resins having both the polysiloxane structure and the epoxy group include EpiFine series (manufactured by KISCO Inc) and ILLUMIKA series (manufactured by Kaneka Corporation).

### [Optical Member]

The optical member of the present invention contains the cured product of a near-infrared light absorbing composition. The cured product of the near-infrared light absorbing composition is, for example, the above-described near-infrared light absorbing cured film.

An example of the optical member includes a visibility correction member for CCD, visibility correction member for CMOS, visibility correction member for other light receiving elements, photometric member, heat ray absorbing member, optical filter, fiber member (optical fiber), noise cutting member, display cover or display filter for plasma display front plate or the like, projector front plate, light source heat ray cutting member, color tone correction member, illumination brightness adjustment member, member for optical amplification element, member for wavelength conversion element, member for Faraday element, isolator member, optical disc member and the like.

Hereinafter, applications of the optical member containing the cured product of the near-infrared light absorbing composition will be exemplified.

### (Near-Infrared Light Cut Filter)

The optical member of the present invention is, for example, a near-infrared light cut filter. The near-infrared light cut filter includes, for example, a near-infrared light absorbing layer on at least one surface of a transparent dielectric substrate. The near-infrared light absorbing layer is the cured product of the near-infrared light absorbing composition of the present invention.

It is preferable to further provide a dielectric multilayer film on at least one surface of the transparent dielectric substrate, from the viewpoint that the spectral characteristics of the near-infrared light cut filter can be more freely adjusted.

The near-infrared light absorbing layer and the dielectric multilayer film may be provided in contact with the transparent dielectric substrate, or may be provided with another intermediate layer interposed therebetween.

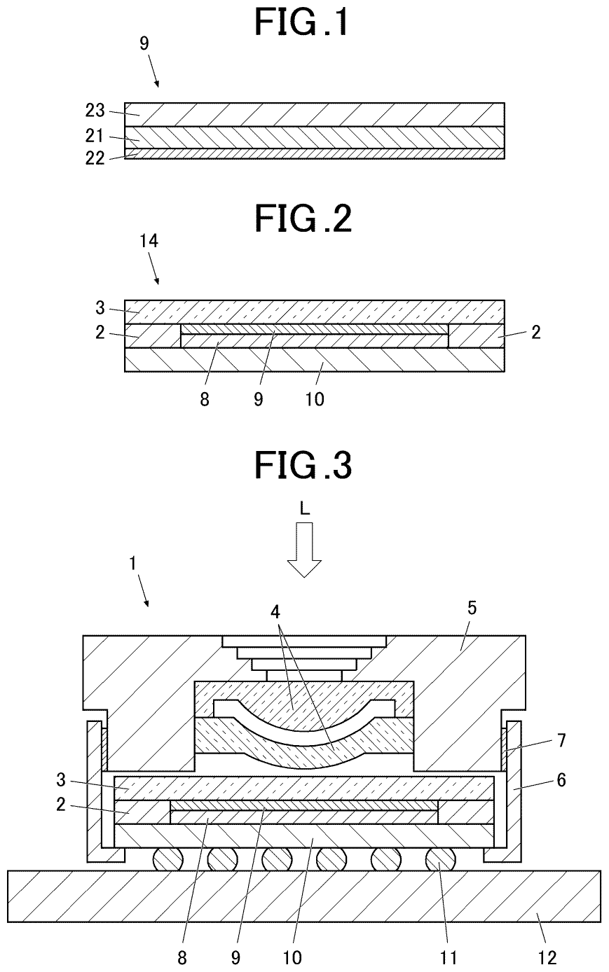

FIG. 1 is a schematic cross-sectional view showing a configuration example of a near-infrared light cut filter.

The near-infrared light cut filter 9 illustrated in FIG. 1 includes a near-infrared light absorbing layer 22 on one surface of a transparent dielectric substrate 21, and further includes a dielectric multilayer film 23 on the other surface thereof.

The material of the transparent dielectric substrate is not particularly limited. The transparent dielectric substrate may be made of, for example, glass, or an optical resin such as polycarbonate (PC), polymethyl methacrylate (PMMA), cycloolefin polymer (COP), or silicone.

The transparent dielectric substrate is preferably 0.01 to 1 mm thick.

Since the transparent dielectric substrate needs to transmit visible light, it preferably has an average spectral transmittance of 80% or more in the range of a wavelength of 450 to 600 nm.

The dielectric multilayer film is a film formed by stacking a plurality of layers made of materials having different refractive indexes, and is used for controlling the transmittance of each wavelength of light. By providing the dielectric multilayer film in combination with the near-infrared light absorbing layer, it is possible to more freely adjust the spectral characteristics of the near-infrared light cut filter.

The spectral characteristics of the dielectric multilayer film can be adjusted by the thickness and the type of material of each layer of the dielectric multilayer film. As a material of each layer of the dielectric multilayer film, for example, a dielectric such as titanium oxide, silicon oxide, aluminum oxide, zirconium oxide, tantalum pentoxide, niobium pentoxide, lanthanum oxide, yttrium oxide, zinc oxide, zinc sulfide, indium oxide, silica, alumina, lanthanum fluoride, magnesium fluoride, or sodium aluminum hexafluoride can be used.

The near-infrared light cut filter including the dielectric multilayer film can be produced by stacking each dielectric layer on the transparent dielectric substrate by a method such as a vacuum deposition method, a chemical vapor deposition method, or a sputtering method. The near-infrared light cut filter including the dielectric multilayer film can also be produced by bonding a separately produced dielectric multilayer film to a transparent dielectric substrate with an adhesive.

### (Image Sensor For Solid State Imaging Device)

The near-infrared light cut filter can be included in the image sensor for the solid state imaging device. The image sensor for the solid state imaging device is a member mainly composed of a solid state imaging device substrate including the light receiving element. The image sensor for the solid state imaging device may include a planarization layer, a glass substrate, and the like in addition to the near-infrared light cut filter.

FIG. 2 is a schematic cross-sectional view illustrating an example of the configuration of the image sensor for the solid state imaging device.

The solid state imaging device image sensor 14 illustrated in FIG. 2 is configured by a solid state imaging device substrate 10 including a light receiving element on a surface of a light receiving side of a silicone substrate, a planarization layer 8 provided on the solid state imaging device substrate 10, a near-infrared light cut filter 9 provided on the planarization layer 8, and a glass substrate 3 (light transmitting substrate) disposed on the near-infrared light cut filter 9. Each member is bonded by an adhesive 2.

### (Camera Module)

The image sensor for a solid state imaging device may be included in a camera module. The camera module may include, in addition to the image sensor for the solid state imaging device, an imaging lens, a lens holder, a light shielding and electromagnetic shield, and the like.

FIG. 3 is a schematic cross-sectional view illustrating an example of a configuration of the camera module.

The camera module 1 illustrated in FIG. 3 is configured to include the image sensor for the solid state imaging device as in FIG. 2, a lens holder 5, an imaging lens 4, and a light shielding and electromagnetic shield 6. Similarly to FIG. 2, the image sensor for the solid state imaging device includes the solid state imaging device substrate 10, the planarization layer 8, the near-infrared light cut filter 9, and the glass substrate 3. The light shielding and electromagnetic shield 6 is arranged so as to surround the periphery of the image sensor for the solid state imaging device. The respective members are bonded by the adhesive 7.

Furthermore, the camera module 1 is connected to a circuit board 12 which is a mounting board, via a solder member 11 (connection material) which are connection members.

In the camera module 1, incident light L from the outside sequentially passes through the imaging lens 4, the glass substrate 3, the near-infrared light cut filter 9, and the planarization layer 8, and then reaches the light receiving element of the solid state imaging device substrate 10.

### EXAMPLE

Hereinafter, the present invention will be specifically described with reference to Examples, but the present invention is not limited thereto. In the following Examples, operations were performed at room temperature (25° C.) unless otherwise specified. In the following Examples, unless otherwise specified, “%” and “parts” mean “% by mass” and “parts by mass”, respectively.

### <Synthesis of Phosphate Ester>

Exemplary Compounds 63, 75, and 79, which are phosphate esters, were synthesized by the following sequence.

### (Synthesis Procedure of Exemplary Compound 63)

2-ethylhexanol [130 g (1.0 mol)] was placed in the autoclave. To this was added propylene oxide [116 g (2.0 mol)] using the potassium hydroxide as the catalyst under the conditions of the pressure of 147 kPa and the temperature of 130° C. Thereafter, further ethyleneoxide [88 g (2.0 mol)] was added thereto. Then, after confirming that no 2-ethylhexanol remained, the above adduct was taken into the reactor. With this, using the toluene solution, the phosphoric anhydride [47 g (0.33 mol)] was reacted at 80° C. for 5 hours. The reaction product was washed with the distilled water, and the solvent was distilled under the reduced pressure. Thus, Exemplary Compound 63 was obtained.

### (Synthesis Procedure of Exemplary Compound 75)

n-Dodecanol [186 g (1.0 mol)] was placed in the autoclave. To this was added propylene oxide [87 g (1.5 mol)] using the potassium hydroxide as the catalyst under conditions of the pressure of 147 kPa and the temperature of 130° C. Thereafter, further ethyleneoxide [66 g (1.5 mol)] was added thereto. Next, after confirming that n-dodecanol did not remain, the above adduct was taken into the reactor. With this, using the toluene solution, the phosphoric anhydride [47 g (0.33 mol)] was reacted at 80° C. for 5 hours. The reaction product was washed with the distilled water, and the solvent was distilled under the reduced pressure. Thus, Exemplary Compound 75 was obtained.

### (Synthesis Procedure of Exemplary Compound 79)

n-Dodecanol [186 g (1.0 mol)] was placed in the autoclave. To this was added propylene oxide [116 g (2.0 mol)] using the potassium hydroxide as the catalyst under the conditions of the pressure of 147 kPa and the temperature of 130° C. Thereafter, further ethyleneoxide [88 g (2.0 mol)] was added thereto. Next, after confirming that n-dodecanol did not remain, the above adduct was taken into the reactor. With this, using the toluene solution, the phosphoric anhydride [47 g (0.33 mol)] was reacted at 80° C. for 5 hours. The reaction product was washed with the distilled water, and the solvent was distilled under the reduced pressure. Thus, Exemplary Compound 79 was obtained.

### <Preparation of Antioxidant-Containing Solvent>

The solvent and the antioxidant listed in Table VI were mixed to prepare antioxidant-containing solvents 1 to 21. Details of the antioxidant used are as described above.

TABLE VI

| ANTIOXIDANT- | SOLVENT | | ANTIOXIDANT 1 | | ANTIOXIDANT 2 | |
|---|---|---|---|---|---|---|
| CONTAINING | | MIXING | | MIXING | | MIXING |
| SOLVENT | | AMOUNT | | AMOUNT | | AMOUNT |
| No. | TYPE | [% BY MASS] | TYPE | [% BY MASS] | TYPE | [% BY MASS] |
| 1 | 4-METHYLTETRAHY- | 99.95 | Sumilizer | 0.05 | — | — |
| | DROPYRAN | | GS | | | |
| 2 | CYCLOPENTYL | 99.95 | Sumilizer | 0.05 | — | — |
| | METHYL ETHER | | GS | | | |
| 3 | CYCLOPENTYL | 99.95 | ADEKA STAB | 0.05 | — | — |
| | METHYL ETHER | | LA-72 | | | |
| 4 | CYCLOPENTYL | 99.95 | ADEKA STAB | 0.05 | — | — |
| | METHYL ETHER | | LA-81 | | | |
| 5 | CYCLOPENTYL | 99.95 | ADEKA STAB | 0.05 | — | — |
| | METHYL ETHER | | PEP-8 | | | |
| 6 | CYCLOPENTYL | 99.95 | ADEKA STAB | 0.05 | — | — |
| | METHYL ETHER | | PEP-36 | | | |
| 7 | CYCLOPENTYL | 99.95 | ADEKA STAB | 0.05 | — | — |
| | METHYL ETHER | | 2112 | | | |
| 8 | CYCLOPENTYL | 99.95 | ADEKA STAB | 0.05 | — | — |
| | METHYL ETHER | | A0-412S | | | |
| 9 | CYCLOPENTYL | 99.9 | Sumilizer | 0.05 | ADEKA STAB | 0.05 |
| | METHYL ETHER | | GS | | PEP-8 | |
| 10 | CYCLOPENTYL | 99.9 | Sumilizer | 0.05 | ADEKA STAB | 0.05 |
| | METHYL ETHER | | GS | | PEP-36 | |
| 11 | CYCLOPENTYL | 99.9 | Sumilizer | 0.05 | ADEKA STAB | 0.05 |
| | METHYL ETHER | | GS | | A0-412S | |
| 12 | CYCLOPENTYL | 99.9 | ADEKA STAB | 0.05 | ADEKA STAB | 0.05 |
| | METHYL ETHER | | LA-72 | | PEP-8 | |
| 13 | CYCLOPENTYL | 99.9 | ADEKA STAB | 0.05 | ADEKA STAB | 0.05 |
| | METHYL ETHER | | LA-72 | | PEP-36 | |
| 14 | CYCLOPENTYL | 99.9 | ADEKA STAB | 0.05 | ADEKA STAB | 0.05 |
| | METHYL ETHER | | LA-72 | | A0-412S | |
| 15 | DIBUTYL ETHER | 99.95 | Sumilizer | 0.05 | — | — |
| | | | GS | | | |
| 16 | CYCLOPENTYL | 99.95 | Irganox | 0.05 | — | — |
| | METHYL ETHER | | 1010 | | | |
| 17 | CYCLOPENTYL | 99.95 | Irganox | 0.05 | — | — |
| | METHYL ETHER | | 245 | | | |
| 18 | CYCLOPENTYL | 99.95 | Sumilizer | 0.05 | — | — |
| | METHYL ETHER | | GM | | | |
| 19 | CYCLOPENTYL | 99.95 | Sumilizer | 0.05 | — | — |
| | METHYL ETHER | | GP | | | |
| 20 | ETHANOL | 99.95 | Sumilizer | 0.05 | — | — |
| | | | GS | | | |
| 21 | CYCLOPENTYL | 100 | — | — | — | — |
| | METHYL ETHER | | | | | |

### <Preparation of Near-Infrared Light Absorbing Composition 1>

Copper acetate (II) mono-hydrate [1.82 g, 10 mmol] and antioxidant-containing solvent 1 [82 g] were mixed and stirred for 3 hours. The liquid was filtered to remove insoluble matter. The resulting solution is referred to as Solution A.

Plysurf A208N [1.6 mmol] as the phosphate ester was dissolved in the antioxidant-containing solvent 1 [7 g]. To this, the solution A was added and stirred at room temperature for 30 minutes. The resulting solution is referred to as Solution B.

Propylphosphonate [8.8 mmol] as phosphonate was dissolved in the antioxidant-containing solvent-1 [7 g]. The resulting solution is referred to as Solution C.

The Solution C was added to Solution B while stirring. The system was stirred at room temperature for 16 hours. The resulting solution is referred to as Solution D.

The total amount of the Solution D and methylcyclohexane [30 g] were placed in a flask. While heating this at 50 to 100° C. in an oil bath (manufactured by Tokyo Rikakikai Co., Ltd., model: OSB-2100), a rotary evaporator (manufactured by Tokyo Rikakikai Co., Ltd., model: N-1000) performed the process of removing the solvent and the acetic acid for 40 minutes. Thus, the concentration of a near-infrared light absorbent (copper phosphonate complex and phosphate ester) of this system was adjusted to 20% by mass. This treatment for the Solution D is referred to as the azeotropic treatment.

Thereafter, the antioxidant-containing solvent 1 was added to this system to adjust the concentration of the near-infrared light absorbent (copper phosphonate complex and phosphate ester) to 10% by mass. Thus, a near-infrared light absorbing composition 1 was obtained.

### <Preparation of Near-Infrared Light Absorbing Compositions 2 to 25 and 31 to 36>

Near-infrared light absorbing compositions 2 to 25 and 31 to 36 were prepared in the same manner as the preparation of the near-infrared light absorbing composition 1 except that the kinds of the antioxidant-containing solvent, the phosphonic acid, and the phosphate ester to be used were changed as illustrated in Table VII, respectively.

Note that the amount of the phosphate ester added in the Solution B was 1.6 mmol regardless of the type of the phosphate ester. The amount of the phosphonic acid added in the Solution C was 8.8 mmol regardless of the type of the phosphonic acid.

The near-infrared light absorbing composition corresponding to “none” in the column of “azeotropic treatment” in Table VII was prepared without performing the azeotropic treatment.

### <Preparation of Near-Infrared Light Absorbing Composition 26>

A near-infrared light absorbing composition 26′ in which the concentration of the near-infrared light absorbent (the copper phosphonate complex and the phosphate ester) was 10% by mass was prepared in the same manner as in the preparation of the near-infrared light absorbing composition 1 except that the kinds of the antioxidant-containing solvent, the phosphonic acid, and the phosphate ester to be used were changed as illustrated in Table VII, respectively.

As a titanium coupling agent, Orgatics TC-245 (manufactured by Matsumoto Fine Chemical Co., Ltd., an organic titanium compound) was dissolved in an antioxidant-containing solvent 2 to prepare a titanium coupling agent solution having a titanium coupling agent concentration of 10% by mass.

The titanium coupling agent solution [0.5 parts by mass] was added to the near-infrared light absorbing composition 26′[10 parts by mass], and the mixture was stirred at room temperature for 10 minutes to prepare a near-infrared light absorbing composition 26. In the near-infrared light absorbing composition 26, the content of the titanium coupling agent is 5% by mass when the content of the near-infrared light absorbent (copper phosphonate complex and phosphate ester) is taken as 100% by mass.

### <Preparation of Near-Infrared Light Absorbing Compositions 27 to 30>

Near-infrared light absorbing compositions 27 to 30 were prepared in the same manner as the preparation of the near-infrared light absorbing composition 26, except that the kinds of the antioxidant-containing solvent, the phosphonic acid, the phosphate ester, and the titanium coupling agent to be used were changed as shown in Table VII, respectively.

Orgatics TC-800 used as the titanium coupling agent in the preparation of the near-infrared light absorbing compositions 27 to 30 is an organic titanium compound manufactured by Matsumoto Fine Chemical Co., Ltd.

### <Measurement of Acetate Ion Concentration>

The near-infrared light absorbing composition [about 2 g] and the ultrapure water [2.5 mL] were mixed and shaken for 10 minutes. This was centrifuged, and the aqueous phase was removed. The acetate ion concentration of the extracted aqueous phase was measured using the organic acid migration solution and the capillary electrophoresis apparatus. The measured acetate ion concentrations were as listed in Table VII.

### <Evaluation of Dispersibility>

The near-infrared light absorbing composition immediately after the preparation was diluted with toluene so that the solid content concentration became 0.5% by mass. The average particle diameter of the fine particles in the diluted dispersion liquid was measured by a dynamic light scattering method using a zeta potential/particle size measuring system (ELSZ 1000ZS, manufactured by Otsuka Electronics Co., Ltd). Based on the measured average particle diameter, dispersibility was evaluated according to the following evaluation criterion. The evaluation results are as shown in Table VIII.
AA: The average particle diameter is less than or equal to 100 nm.
A: The average particle diameter is more than 100 nm and 500 nm or less.
B: The average particle diameter is more than 500 nm and 1000 nm or less.
C: The average particle diameter is more than 1000 nm.

### <Evaluation of Liquid Storage Stability>

The near-infrared light absorbing composition is allowed to stand at room temperature for one month, the mixture was diluted with toluene so that the solid content concentration was 0.5% by mass. The average particle diameter of the fine particles in the diluted dispersion liquid was measured by a dynamic light scattering method using a zeta potential/particle size measuring system (ELSZ 1000ZS, manufactured by Otsuka Electronics Co., Ltd). Based on the measured average particle diameter, the storage stability was evaluated according to the following evaluation criterion. The evaluation results are as shown in Table VIII.
AA: The average particle diameter is less than or equal to 100 nm.
A: The average particle diameter is more than 100 nm and 500 nm or less.
B: The average particle diameter is more than 500 nm and 1000 nm or less.
C: The average particle diameter is more than 1000 nm.

### <Evaluation of Heat Coloring Resistance>

Three droplets of the near-infrared light absorbing composition were dropped onto a slide glass, and the slide glass was heated on a hot plate at 70° C. A slide glass was placed on the droplet, and the two slide glasses were bonded together. This was heated at 150° C. for 15 minutes and further heated at 175° C. for 15 minutes. Tristimulus values X, Y and Z of a light source color defined in JIS Z8701 of this sample were measured with a spectrophotometer (Spectrophotometer V-780, manufactured by JASCO Corporation).

A yellow index (yellowness index) YI was calculated from the following formula.

YI=100(1.2985X−1.1335Z)/Y

Further, ΔYI was calculated from the following equation.

ΔYI=YI−YI₀
YI₀: YI when the near-infrared light absorbing composition not containing the antioxidant is evaluated in the same manner

Based on the calculated ΔYI, heat coloring resistance was evaluated according to the following evaluation criterion. The evaluation results are as shown in Table VIII.
A: ΔYI is 1 or less.
B: ΔYI is more than 1 and 3 or less.
C: ΔYI is more than 3.

### <Evaluation of Peroxide Increase Resistance>

A sample was prepared by adding 0.35% by mass of each antioxidant to tetrahydrofuran not containing any antioxidant. This sample was dissolved in a mixed solvent of acetic acid/chloroform (3:2) serving as a titration solvent. To this was added saturated potassium iodide solution under nitrogen atmosphere, and then plugged. This was left in the dark for about 10 minutes to liberate iodine. The sample after being left was titrated with a sodium thiosulfate standard solution, and the amount of peroxide [meq/kg] was obtained. The titration was performed by potentiometric titration using an automatic titrator and a platinum electrode. As an automatic titrator, GT-200 manufactured by Mitsubishi Chemical Analytech Co., Ltd. was used. The sample was left to stand at room temperature for one month, and then titration was performed again to determine the amount of peroxide [meq/kg]. The increased amount of peroxide [meq/kg] was calculated from the amount of peroxide before and after standing for one month.

Based on the calculated peroxide increase amount [meq/kg], the resistance to peroxide increase was evaluated according to the following evaluation criterion. The evaluation results are as shown in Table VIII.
AA: The peroxide increased amount is 5 meq/kg or less.
A: The peroxide increased amount is more than 5 meq/kg and 10 meq/kg or less.
B: The peroxide increased amount is more than 10 meq/kg and 15 meq/kg or less.
C: The peroxide increased amount is more than 15 meq/kg.

TABLE VII

| | | | | TITANIUM | | | |
|---|---|---|---|---|---|---|---|
| | | | | COUPLING | AZEOTROPIC | | |
| No. | PHOSPHONIC ACID | PHOSPHATE ESTER | *1 | AGENT | TREATMENT | *2 | REMARKS |
| 1 | PROPYLPHOSPHONIC ACID | PLYSURF A208N | 1 | — | NO | 1.30 | PRESENT INVENTION |
| 2 | PROPYLPHOSPHONIC ACID | PLYSURF A208N | 2 | — | NO | 1.30 | PRESENT INVENTION |
| 3 | PROPYLPHOSPHONIC ACID | PLYSURF A208N | 1 | — | YES | 0.05 | PRESENT INVENTION |
| 4 | PROPYLPHOSPHONIC ACID | PLYSURF A208N | 1 | — | YES | 0.05 | PRESENT INVENTION |
| 5 | PROPYLPHOSPHONIC ACID | PLYSURF A208N | 1 | — | YES | 0.50 | PRESENT INVENTION |
| 6 | n-BUTYLPHOSPHONIC ACID | PLYSURF A208N | 1 | — | YES | 0.05 | PRESENT INVENTION |
| 7 | n-BUTYLPHOSPHONIC ACID | EXEMPLARY COMPOUND 63 | 1 | — | YES | 0.05 | PRESENT INVENTION |
| 8 | n-BUTYLPHOSPHONIC ACID | EXEMPLARY COMPOUND 75 | 1 | — | YES | 0.05 | PRESENT INVENTION |
| 9 | n-BUTYLPHOSPHONIC ACID | EXEMPLARY COMPOUND 79 | 1 | — | YES | 0.05 | PRESENT INVENTION |
| 10 | n-BUTYLPHOSPHONIC ACID | EXEMPLARY COMPOUND 75 | 3 | — | YES | 0.05 | PRESENT INVENTION |
| 11 | n-BUTYLPHOSPHONIC ACID | EXEMPLARY COMPOUND 75 | 4 | — | YES | 0.05 | PRESENT INVENTION |
| 12 | n-BUTYLPHOSPHONIC ACID | EXEMPLARY COMPOUND 75 | 5 | — | YES | 0.05 | PRESENT INVENTION |
| 13 | n-BUTYLPHOSPHONIC ACID | EXEMPLARY COMPOUND 75 | 6 | — | YES | 0.05 | PRESENT INVENTION |
| 14 | n-BUTYLPHOSPHONIC ACID | EXEMPLARY COMPOUND 75 | 7 | — | YES | 0.05 | PRESENT INVENTION |
| 15 | n-BUTYLPHOSPHONIC ACID | EXEMPLARY COMPOUND 75 | 8 | — | YES | 0.05 | PRESENT INVENTION |
| 16 | n-BUTYLPHOSPHONIC ACID | EXEMPLARY COMPOUND 75 | 9 | — | YES | 0.05 | PRESENT INVENTION |
| 17 | n-BUTYLPHOSPHONIC ACID | EXEMPLARY COMPOUND 75 | 10 | — | YES | 0.05 | PRESENT INVENTION |
| 18 | n-BUTYLPHOSPHONIC ACID | EXEMPLARY COMPOUND 75 | 11 | — | YES | 0.05 | PRESENT INVENTION |
| 19 | n-BUTYLPHOSPHONIC ACID | EXEMPLARY COMPOUND 75 | 12 | — | YES | 0.05 | PRESENT INVENTION |
| 20 | n-BUTYLPHOSPHONIC ACID | EXEMPLARY COMPOUND 75 | 13 | — | YES | 0.05 | PRESENT INVENTION |
| 21 | n-BUTYLPHOSPHONIC ACID | EXEMPLARY COMPOUND 75 | 14 | — | YES | 0.05 | PRESENT INVENTION |
| 22 | n-BUTYLPHOSPHONIC ACID | EXEMPLARY COMPOUND 75 | 14 | — | YES | 0.05 | PRESENT INVENTION |
| 23 | HEXYLPHOSPHONIC ACID | EXEMPLARY COMPOUND 75 | 14 | — | YES | 0.05 | PRESENT INVENTION |
| 24 | OCTYLPHOSPHONIC ACID | EXEMPLARY COMPOUND 75 | 14 | — | YES | 0.05 | PRESENT INVENTION |
| 25 | n-BUTYLPHOSPHONIC ACID | EXEMPLARY COMPOUND 75 | 15 | — | NO | 1.30 | PRESENT INVENTION |
| 26 | n-BUTYLPHOSPHONIC ACID | EXEMPLARY COMPOUND 75 | 2 | TC245 | NO | 0.05 | PRESENT INVENTION |
| 27 | n-BUTYLPHOSPHONIC ACID | EXEMPLARY COMPOUND 75 | 2 | TC800 | NO | 1.30 | PRESENT INVENTION |
| 28 | n-BUTYLPHOSPHONIC ACID | EXEMPLARY COMPOUND 75 | 3 | TC800 | NO | 1.30 | PRESENT INVENTION |
| 29 | n-BUTYLPHOSPHONIC ACID | EXEMPLARY COMPOUND 75 | 13 | TC800 | NO | 1.30 | PRESENT INVENTION |
| 30 | n-BUTYLPHOSPHONIC ACID | EXEMPLARY COMPOUND 75 | 13 | TC800 | NO | 1.30 | PRESENT INVENTION |
| 31 | n-BUTYLPHOSPHONIC ACID | EXEMPLARY COMPOUND 75 | 16 | — | NO | 1.30 | COMPARATIVE EXAMPLE |
| 32 | n-BUTYLPHOSPHONIC ACID | EXEMPLARY COMPOUND 75 | 17 | — | NO | 1.30 | COMPARATIVE EXAMPLE |
| 33 | n-BUTYLPHOSPHONIC ACID | EXEMPLARY COMPOUND 75 | 18 | — | NO | 1.30 | COMPARATIVE EXAMPLE |
| 34 | n-BUTYLPHOSPHONIC ACID | EXEMPLARY COMPOUND 75 | 19 | — | NO | 1.30 | COMPARATIVE EXAMPLE |
| 35 | n-BUTYLPHOSPHONIC ACID | EXEMPLARY COMPOUND 75 | 20 | — | NO | 1.30 | COMPARATIVE EXAMPLE |
| 36 | n-BUTYLPHOSPHONIC ACID | EXEMPLARY COMPOUND 75 | 21 | — | YES | 0.05 | COMPARATIVE EXAMPLE |

*1: ANTIOXIDANT-CONTAINING SOLVENT
*2: ACETATE ION CONCENTRATION [% BY MASS]

TABLE VIII

| | | LIQUID | HEAT | PEROXIDE | |
|---|---|---|---|---|---|
| | | STORAGE | COLORING | INCREASE | |
| No. | DISPERSIBILITY | STABILITY | RESISTANCE | RESISTANCE | REMARKS |
| 1 | AA | B | A | A | PRESENT INVENTION |
| 2 | AA | B | A | A | PRESENT INVENTION |
| 3 | AA | A | A | A | PRESENT INVENTION |
| 4 | AA | A | A | A | PRESENT INVENTION |
| 5 | AA | A | A | A | PRESENT INVENTION |
| 6 | AA | A | A | A | PRESENT INVENTION |
| 7 | AA | A | A | A | PRESENT INVENTION |
| 8 | AA | A | A | A | PRESENT INVENTION |
| 9 | AA | A | A | A | PRESENT INVENTION |
| 10 | AA | A | A | A | PRESENT INVENTION |
| 11 | AA | A | A | A | PRESENT INVENTION |
| 12 | AA | B | A | A | PRESENT INVENTION |
| 13 | AA | B | A | A | PRESENT INVENTION |
| 14 | AA | B | A | A | PRESENT INVENTION |
| 15 | AA | A | A | A | PRESENT INVENTION |
| 16 | AA | B | A | AA | PRESENT INVENTION |
| 17 | AA | B | A | AA | PRESENT INVENTION |
| 18 | AA | A | A | AA | PRESENT INVENTION |
| 19 | AA | B | A | AA | PRESENT INVENTION |
| 20 | AA | B | A | AA | PRESENT INVENTION |
| 21 | AA | A | A | AA | PRESENT INVENTION |
| 22 | AA | A | A | AA | PRESENT INVENTION |
| 23 | A | A | A | AA | PRESENT INVENTION |
| 24 | A | A | A | AA | PRESENT INVENTION |
| 25 | B | B | A | A | PRESENT INVENTION |
| 26 | AA | AA | A | A | PRESENT INVENTION |
| 27 | AA | AA | A | A | PRESENT INVENTION |
| 28 | AA | AA | A | A | PRESENT INVENTION |
| 29 | AA | B | A | AA | PRESENT INVENTION |
| 30 | AA | B | A | AA | PRESENT INVENTION |
| 31 | AA | B | C | A | COMPARATIVE EXAMPLE |
| 32 | AA | B | C | A | COMPARATIVE EXAMPLE |
| 33 | AA | B | C | A | COMPARATIVE EXAMPLE |
| 34 | AA | B | C | A | COMPARATIVE EXAMPLE |
| 35 | C | A | A | AA | COMPARATIVE EXAMPLE |
| 36 | AA | B | A | C | COMPARATIVE EXAMPLE |

From the above results, it can be confirmed that the near-infrared light absorbing composition of the present invention is less likely to be colored by heating while having the function of preventing oxidation of the solvent.

### INDUSTRIAL APPLICABILITY

The present invention can be used for a near-infrared light absorbing composition and an optical member.

### REFERENCE SIGNS LIST

1 camera module
2 adhesive
3 glass substrate
4 imaging lens
5 lens holder
6 light shielding and electromagnetic shield
7 adhesive
8 planarization layer
9 near-infrared light cut filter
10 solid state imaging device substrate
11 solder ball
12 circuit board
14 solid state imaging device image sensor
21 transparent dielectric substrate
22 near-infrared light absorbing layer
23 dielectric multilayer film

1. A near-infrared light absorbing composition comprising:
a copper phosphonate complex,
wherein the near-infrared light absorbing composition further includes, a phosphate ester, a solvent, and an antioxidant,
wherein the near-infrared light absorbing composition includes at least an ether-based solvent as the solvent, and
wherein the near-infrared light absorbing composition includes as the antioxidant, at least one type selected from a phenol-based antioxidant having a structure represented by the following General Formula (1), an amine-based antioxidant having a structure represented by the following General Formula (2), a phosphorus-based antioxidant having a structure represented by the following General Formula (3) or (4), and a sulfur-based antioxidant having a structure represented by the following General Formula (5).
[Chemical Formula 1] 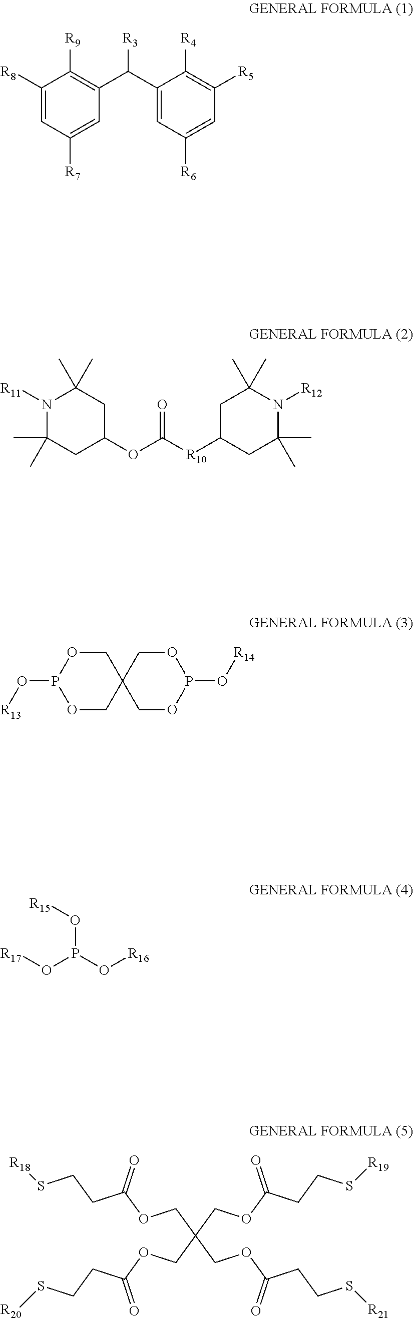
[In the General Formulas (1) to (5), R₃ is the alkyl group having 1 to 4 carbon atoms. R₄ to R₉ are substituent groups selected from a hydroxy group, an acyloxy group, and the alkyl group. At least one among R₄ to R₉ is the hydroxy group, and at least one of the others is the acyloxy group. R₁₀ is oxygen or the alkylene ester group having 1 to 20 carbon atoms, and may further have a substituent group. R₁₁ and R₁₂ are hydrogen, the alkyl group having 1 to 20, or an alkoxy group having 1 to 20 carbon atoms. R₁₃ to R₂₁ are the alkyl group or an aryl group having 1 to 20 carbon atoms, and may further have the substituent group. R₁₅ and R₁₆ may be bonded to each other.]

2. The near-infrared light absorbing composition according to claim 1, further comprising a titanium coupling agent.

3. The near-infrared light absorbing composition according to claim 1, wherein an acetate ion concentration is 0.5% by mass or less.

4. The near-infrared light absorbing composition according to claim 1, wherein the phosphate ester has a structure represented by the following General Formula (II).
[Chemical Formula 2] 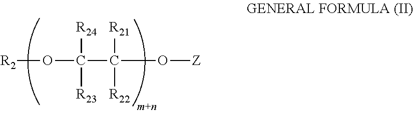
[In the General Formula (II), R₂ represents the alkyl group having 1 to 20 carbon atoms or the aryl group having 6 to 20 carbon atoms, and may further have the substituent group. R₂₁ to R₂₄ each independently represents a hydrogen atom or an alkyl group having 1 to 4 carbon atoms. m represents an average addition number of a partial structural unit in which all of R₂₁ to R₂₄ are hydrogen atoms, and is in a range of 1 to 19. n represents an average addition number of a partial structural unit in which at least one of R₂₁ to R₂₄ is an alkyl group having 1 to 4 carbon atoms, and is in a range of 1 to 19. m+n is a total number of m and n, and is in a range of 2 to 20. Z represents a structural unit selected from the following formula (Z-1) and formula (Z-2).]
[Chemical Formula 3]

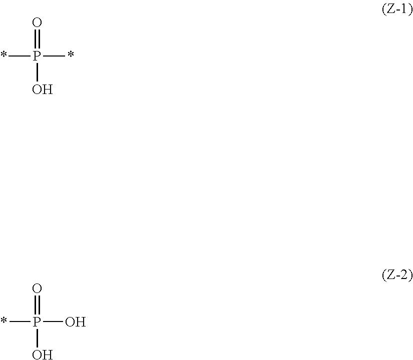 [SMILES: *P(*)(=O)O ; *P(=O)(O)O]

5. The near-infrared light absorbing composition according to claim 1, further comprising, as the antioxidant, at least one type selected from the phenol-based antioxidant and the amine-based antioxidant and at least one type selected from the phosphorus-based antioxidant and the sulfur-based antioxidant.

6. The near-infrared light absorbing composition according to claim 1, further comprising, as the antioxidant, at least one type selected from the phenol-based antioxidant and the amine-based antioxidant.

7. The near-infrared light absorbing composition according to claim 1, wherein a content of the solvent is within a range of 61 to 98% by mass.

8. An optical member comprising:
a cured product of the near-infrared light absorbing composition according to claim 1.
